(19) United States
(12) Patent Application Publication
(10) Pub. No.: US 2024/0410693 A1
(43) Pub. Date: Dec. 12, 2024

(54) IMAGING DEVICE

(71) Applicant: Panasonic Intellectual Property Management Co., Ltd., Osaka (JP)

(72) Inventor: Kunihiro IMAMURA, Osaka (JP)

(21) Appl. No.: 18/813,179

(22) Filed: Aug. 23, 2024

Related U.S. Application Data
(63) Continuation of application No. PCT/JP2023/003977, filed on Feb. 7, 2023.

(30) Foreign Application Priority Data
Feb. 25, 2022 (JP) 2022-027790

(51) Int. Cl. G01C 3/06

(52) U.S. Cl. CPC G01C 3/06

(57) ABSTRACT

An imaging device includes an imager and a projector configured to project pattern light in a first wavelength band to a field-of-view range of the imager. The imager includes: a first imaging element; a second imaging element; an imaging lens; a light-splitting element configured to guide light condensed by the imaging lens, to the first imaging element and the second imaging element; a first filter formed on a light-receiving surface of the first imaging element; and a second filter formed on a light-receiving surface of the second imaging element. The first filter and the second filter each have a plurality of first regions and a plurality of second regions. The first regions transmit light in the first wavelength band. The second regions do not transmit light in the first wavelength band and transmit light in a second wavelength band different from the first wavelength band.

### CROSS REFERENCE TO RELATED APPLICATION

This application is a continuation of International Application No. PCT/JP2023/003977 filed on Feb. 7, 2023, entitled “IMAGING DEVICE”, which claims priority under 35 U.S.C. Section 119 of Japanese Patent Application No. 2022-027790 filed on Feb. 25, 2022, entitled “IMAGING DEVICE”. The disclosures of the above applications are incorporated herein by reference.

### BACKGROUND OF THE INVENTION

### Field of the Invention

The present invention relates to an imaging device capable of measuring the distance to a subject.

### Description of Related Art

To date, an imaging device for applying pattern light to a subject and measuring the distance to the subject has been known. With this type of imaging device, pattern light having a specific pattern (intensity distribution) is applied to a subject, and an image of the subject is captured by an imager. The imaging device stores, in advance, a standard image in which the above pattern is distributed. A pixel block having a highest correlation with a target pixel block on the captured image is searched for on the standard image. The search range is set with a position that is the same as that of the target pixel block, as a standard position. The pixel deviation amount of the pixel block extracted by the search, with respect to the standard position, is detected as a parallax. The distance to the subject is calculated from this parallax by a triangulation method.

With such an imaging device, not only the distance to the subject, but also an image (luminance image) of the subject can be further obtained in order to perform image recognition of the subject. In this case, when the pattern light is applied as described above, the pattern of the pattern light can be seen in the image of the subject. This causes problems such as a decrease in the accuracy of image recognition.

A configuration for solving such problems is described, for example, in Japanese Laid-Open Patent Publication No. 2001-153612. In this configuration, an imaging element for acquiring an RGB image of a subject, an imaging element for receiving pattern light, and a separation optical system for separating RGB light and pattern light reflected from the subject are used. The RGB light and the pattern light separated by the separation optical system are received by the imaging element for RGB light and the imaging element for pattern light, respectively.

In the above imaging device, the reflectance and the light absorption rate of the subject can vary in various ways. Therefore, it is preferable that the range of light intensity (dynamic range) over which image capture and distance calculation can be performed is as wide as possible. In addition, in the case where this imaging device is mounted on a robot or the like that continuously operates, it is preferable that calculation of the distance to a subject is prevented from becoming impossible as much as possible during continuous operation of the robot or the like.

### SUMMARY OF THE INVENTION

An imaging device according to a main aspect of the present invention includes an imager and a projector configured to project pattern light in a first wavelength band to a field-of-view range of the imager. Here, the imager includes: a first imaging element; a second imaging element; an imaging lens; a light-splitting element configured to guide light, from a subject, condensed by the imaging lens, to the first imaging element and the second imaging element; a first filter formed on a light-receiving surface of the first imaging element and having a plurality of first regions configured to transmit light in the first wavelength band and a plurality of second regions configured not to transmit light in the first wavelength band and to transmit light in a second wavelength band different from the first wavelength band; and a second filter formed on a light-receiving surface of the second imaging element and having a plurality of the first regions and a plurality of the second regions.

In the imaging device according to this aspect, since the light from the subject is guided to the first imaging element and the second imaging element, an image of the subject can be captured and the distance to the subject can be calculated based on captured images from these imaging elements. At this time, for example, by making an exposure time for the first imaging element and an exposure time for the second imaging element different from each other, the image capture and distance calculation can be performed in the range of light intensity corresponding to each exposure time. Accordingly, the range (dynamic range) over which image capture and distance calculation can be performed can be expanded. In addition, even if a defect such as a failure occurs in any one of the imaging elements, the distance to the subject can be calculated using the captured image from the other imaging element. Therefore, the calculation of the distance to the subject can be prevented from becoming impossible.

The pattern light is removed by the second regions of the first filter and the second regions of the second filter, so that an image of the subject in which the pattern light is not seen can be generated, for example, using pixel signals from pixels in a range where the light passing through the second regions is received. Accordingly, the calculation of the distance to the subject and the generation of an image of the subject can be realized simultaneously.

The effects and the significance of the present invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1 is a diagram showing a configuration of an imaging device according to an embodiment.

FIG. 2A and FIG. 2B are each a diagram schematically showing a method for setting a pixel block for a first imaging element according to the embodiment.

FIG. 3A and FIG. 3B are diagrams schematically showing the relationships between the optical axis of an imaging lens and the imaging surfaces of the first imaging element and a second imaging element, respectively, according to the embodiment.

FIG. 4A is a diagram showing a configuration of a first filter formed on the imaging surface of the first imaging element according to the embodiment.

FIG. 4B is a diagram showing a configuration of a second filter formed on the imaging surface of the second imaging element.

FIG. 5A and FIG. 5B are diagrams schematically showing states where pattern light projected from a projector is projected on the first filter and the second filter, respectively, according to the embodiment.

FIG. 6A and FIG. 6B are each a diagram schematically showing light incident on the imaging surface of the first imaging element according to the embodiment.

FIG. 7A to FIG. 7D are each a diagram schematically showing a process of searching a matching pixel block that matches a target pixel block on a captured image, on a standard image, according to the embodiment.

FIG. 8A is a graph illustrating the relationship between a correlation value and a search position for a target pixel block to which the pattern light is applied, according to the embodiment.

FIG. 8B is a graph illustrating the relationship between a correlation value and a search position for a target pixel block to which the pattern light is not applied, according to the embodiment.

FIG. 9 is a flowchart showing a process for acquiring a distance to and an image of a subject according to the embodiment.

FIG. 10A is a diagram showing a configuration of a first filter formed on the imaging surface of a first imaging element according to Modification 1.

FIG. 10B is a diagram showing a configuration of a second filter formed on the imaging surface of a second imaging element according to Modification 1.

FIG. 11 is a flowchart showing a process for acquiring a distance and an image according to Modification 1.

FIG. 12 is a diagram showing configurations of a projector and an imager according to Modification 2.

FIG. 13 is a diagram showing other configurations of the projector and the imager according to Modification 2.

FIG. 14 is a diagram showing configurations of a projector and an imager according to Modification 3.

FIG. 15 is a flowchart showing a process for generating a distance image according to Modification 3.

FIG. 16A and FIG. 16B are each a diagram showing a configuration of a first filter according to Modification 4.

FIG. 17A and FIG. 17B are each a diagram showing another configuration of the first filter according to Modification 4.

FIG. 18A and FIG. 18B are diagrams schematically showing the relationships between the optical axis of an imaging lens and the imaging surfaces of a first imaging element and a second imaging element, respectively, according to Modification 5.

FIG. 19 is a diagram schematically showing the resolutions of a luminance image and a distance image according to Modification 5.

FIG. 20 is a diagram showing configurations of a projector and an imager according to another modification.

It is noted that the drawings are solely for description and do not limit the scope of the present invention in any way.

### DETAILED DESCRIPTION

Hereinafter, an embodiment of the present invention will be described with reference to the drawings. For convenience, in each drawing, X, Y, and Z axes that are orthogonal to each other are additionally shown. The X-axis direction is an alignment direction of a projector and an imager, and the Z-axis positive direction is the imaging direction of the imager.

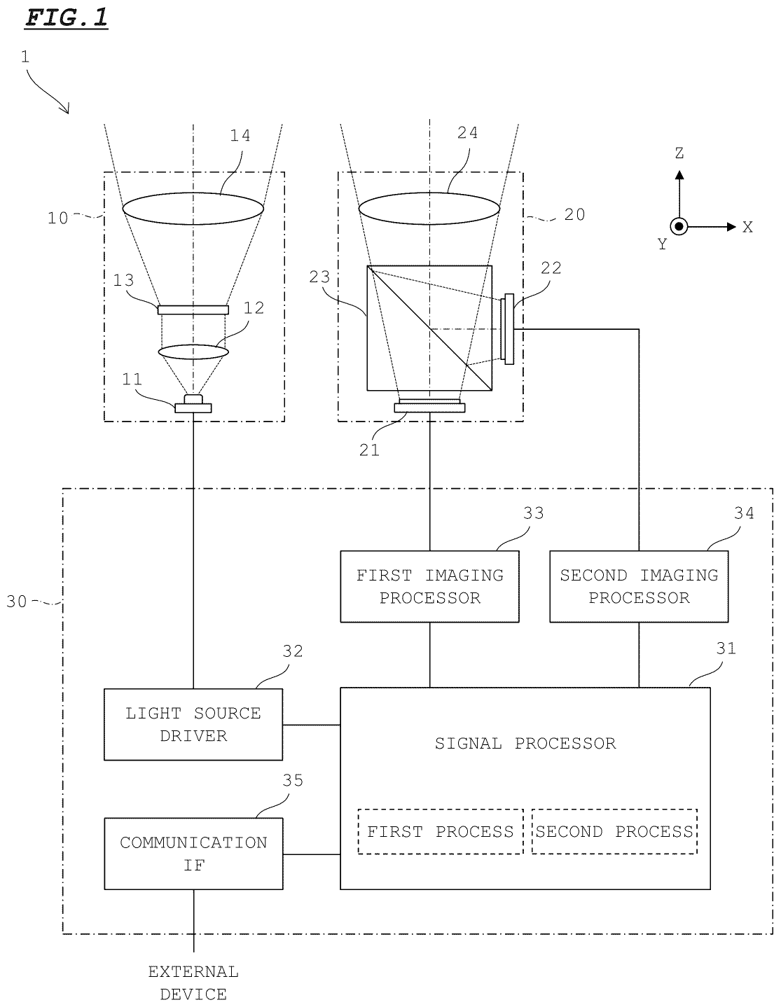

FIG. 1 is a diagram showing a configuration of an imaging device 1.

The imaging device 1 includes a projector 10, an imager 20, and an image processor 30.

The projector 10 projects pattern light distributed in a predetermined pattern, to a field-of-view range of the imager 20. The direction in which the pattern light is projected by the projector 10 is the Z-axis positive direction. The projector 10 includes a light source 11, a collimator lens 12, a pattern generator 13, and a projection lens 14.

The light source 11 emits laser light having a predetermined wavelength. The light source 11 is, for example, a semiconductor laser. The emission wavelength of the light source 11 is, for example, included in the infrared wavelength band. The light source 11 may be another type of light source such as an LED (Light Emitting Diode). The collimator lens 12 converts the light emitted from the light source 11, into substantially collimated light.

The pattern generator 13 generates pattern light from the light emitted from the light source 11. In the present embodiment, the pattern generator 13 is a transmission-type diffractive optical element (DOE). The diffractive optical element (DOE), for example, has a diffraction pattern with a predetermined number of steps on an incident surface thereof. Due to the diffraction action by the diffraction pattern, the laser light incident on the diffractive optical element (pattern generator 13) is divided into a plurality of lights to be converted into a predetermined pattern of light. The generated pattern is a pattern that can maintain uniqueness for each pixel block 102 described later.

In the present embodiment, the pattern generated by the diffractive optical element (DOE) is a pattern in which a plurality of dot regions (hereinafter referred to as “dots”), which are regions through which light passes, are randomly distributed. However, the pattern generated by the diffractive optical element (DOE) is not limited to the pattern with dots, and may be another pattern. The pattern generator 13 may be a reflection-type diffractive optical element, or may be a photomask. Alternatively, the pattern generator 13 may be a device that generates a fixed pattern of pattern light by a control signal, such as a DMD (Digital Mirror Device) and a liquid crystal display.

The projection lens 14 projects the pattern light generated by the pattern generator 13. The projection lens 14 does not have to be a single lens, but may be composed of a combination of multiple lenses. A concave-shaped reflecting mirror may be used instead of the projection lens 14.

The imager 20 includes a first imaging element 21, a second imaging element 22, a light-splitting element 23, and an imaging lens 24.

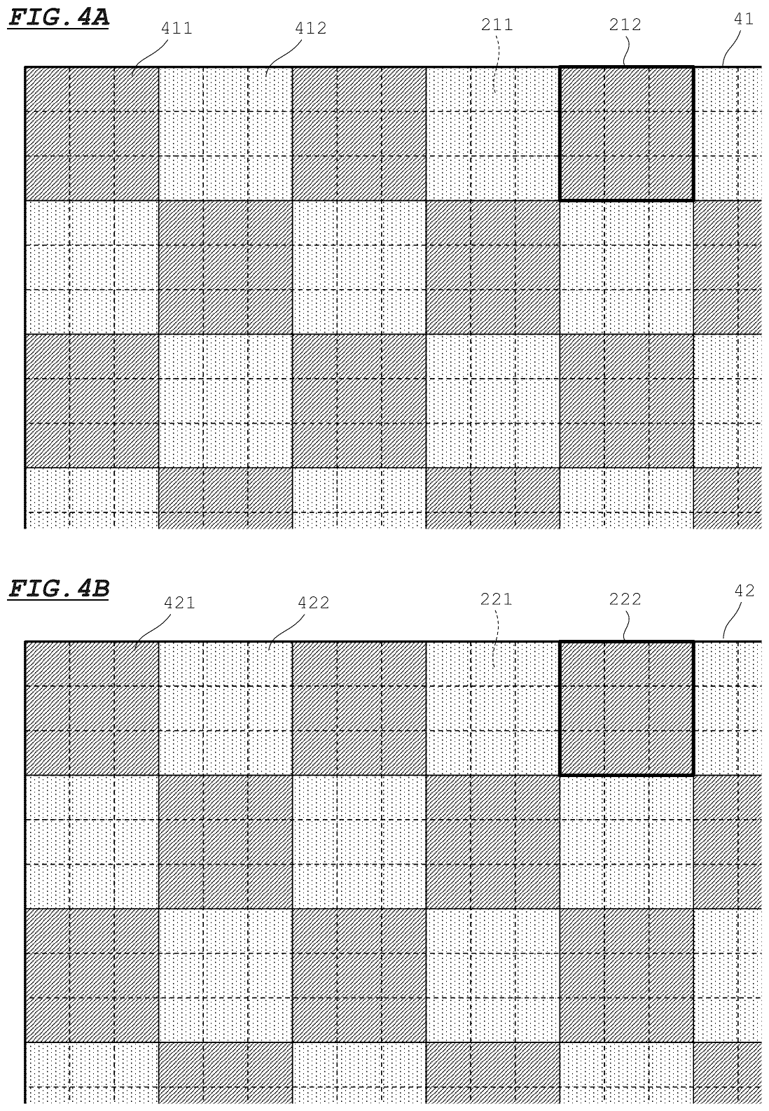

The first imaging element 21 and the second imaging element 22 are CMOS image sensors. The first imaging element 21 and the second imaging element 22 may be CCDs. As described later, a first filter 41 and a second filter 42 (see FIG. 4A and FIG. 4B) are formed on the imaging surfaces of the first imaging element 21 and the second imaging element 22, respectively. In the present embodiment, the first imaging element 21 and the second imaging element 22 have the same configuration as each other.

The light-splitting element 23 splits and guides light, from a subject, condensed by the imaging lens 24, to the first imaging element 21 and the second imaging element 22. The light-splitting element 23 is, for example, a half mirror. The light-splitting element 23 may be another optical element such as a diffractive optical element. The imaging lens 24 condenses light from the field-of-view range, onto the imaging surfaces of the first imaging element 21 and the second imaging element 22. The optical axis of the imaging lens 24 is parallel to the Z-axis.

The image processor 30 includes a signal processor 31, a light source driver 32, a first imaging processor 33, a second imaging processor 34, and a communication interface 35.

The signal processor 31 includes an arithmetic processing circuit such as a microcomputer, and a memory, and controls each part according to a predetermined program. In addition, the signal processor 31 processes pixel signals inputted from the first imaging processor 33 and the second imaging processor 34 to calculate the distance to the subject and generate an image of the subject.

The signal processor 31 stores therein a standard image in which dots are distributed in the same pattern as in the pattern light projected from the projector 10. The signal processor 31 performs a process of comparing this standard image with images captured by the first imaging processor 33 and the second imaging processor 34, respectively, performs a stereo correspondence point search, and calculates the distance to the subject projected on each pixel block on each captured image.

That is, the signal processor 31 sets a pixel block to be the target for distance acquisition (hereinafter referred to as “target pixel block”) on the captured image, and searches for a pixel block corresponding to the target pixel block, that is, a pixel block that best matches the target pixel block (hereinafter referred to as “matching pixel block”), in a search range defined on the standard image. Then, the signal processor 31 performs a process of acquiring a pixel deviation amount between a pixel block at the same position as the target pixel block on the standard image (hereinafter referred to as “standard pixel block”) and the matching pixel block extracted from the standard image by the above search, and calculating the distance to the subject at the position of the target pixel block from the acquired pixel deviation amount by a calculation based on a triangulation method.

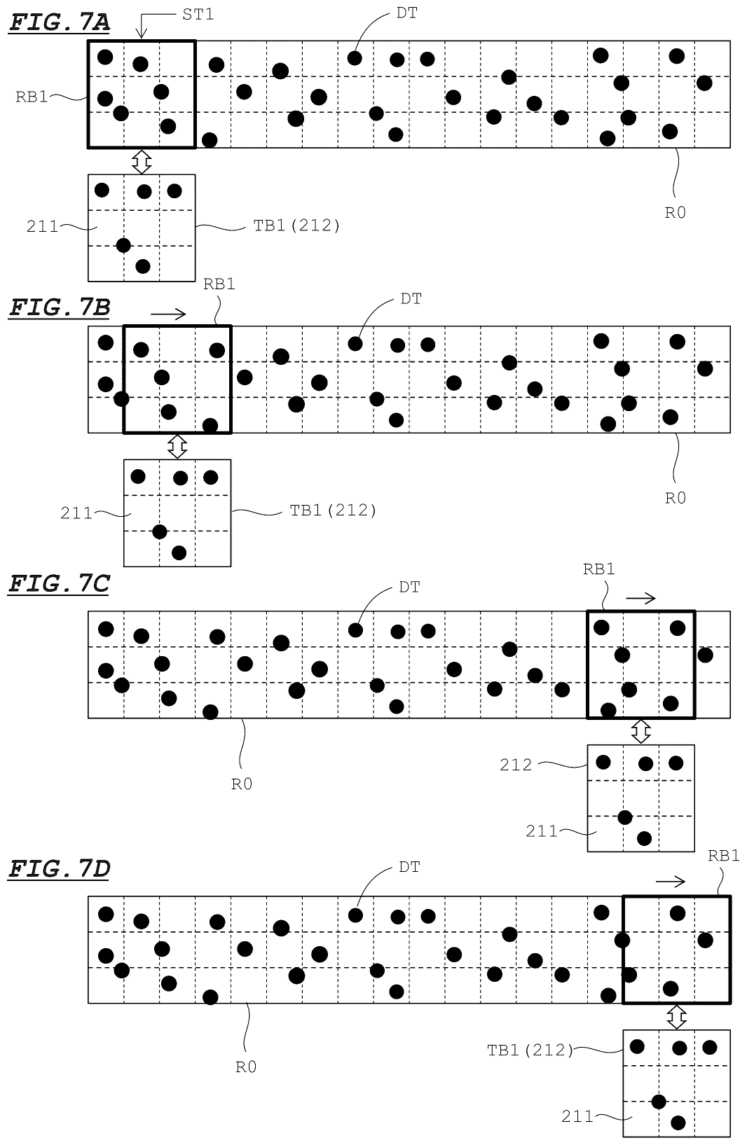

The signal processor 31 generates images including no pattern light dot, from the images captured by the first imaging processor 33 and the second imaging processor 34, respectively. A process for distance calculation and image generation for the subject will be described later with reference to FIG. 7A to FIG. 9.

The signal processor 31 performs a first process of performing distance calculation and image generation on a captured image (pixel signal) from the first imaging element 21, and a second process of performing distance calculation and image generation on a captured image (pixel signal) from the second imaging element 22, in parallel. The signal processor 31 transmits one of distances and one of images acquired by the first process and the second process, respectively, to an external device via the communication interface 35.

The signal processor 31 may execute the first process and the second process by a semiconductor integrated circuit composed of two FPGAs (Field Programmable Gate Arrays). Alternatively, the first process and the second process may be executed by another semiconductor integrated circuit such as a DSP (Digital Signal Processor), a GPU (Graphics Processing Unit), and an ASIC (Application Specific Integrated Circuit).

The light source driver 32 drives the light source 11 under control from the signal processor 31. The first imaging processor 33 controls the first imaging element 21 and performs processing such as luminance correction and camera calibration on the pixel signal of the captured image outputted from the first imaging element 21. The second imaging processor 34 controls the second imaging element 22 and performs processing such as luminance correction and camera calibration on the pixel signal of the captured image outputted from the second imaging element 22.

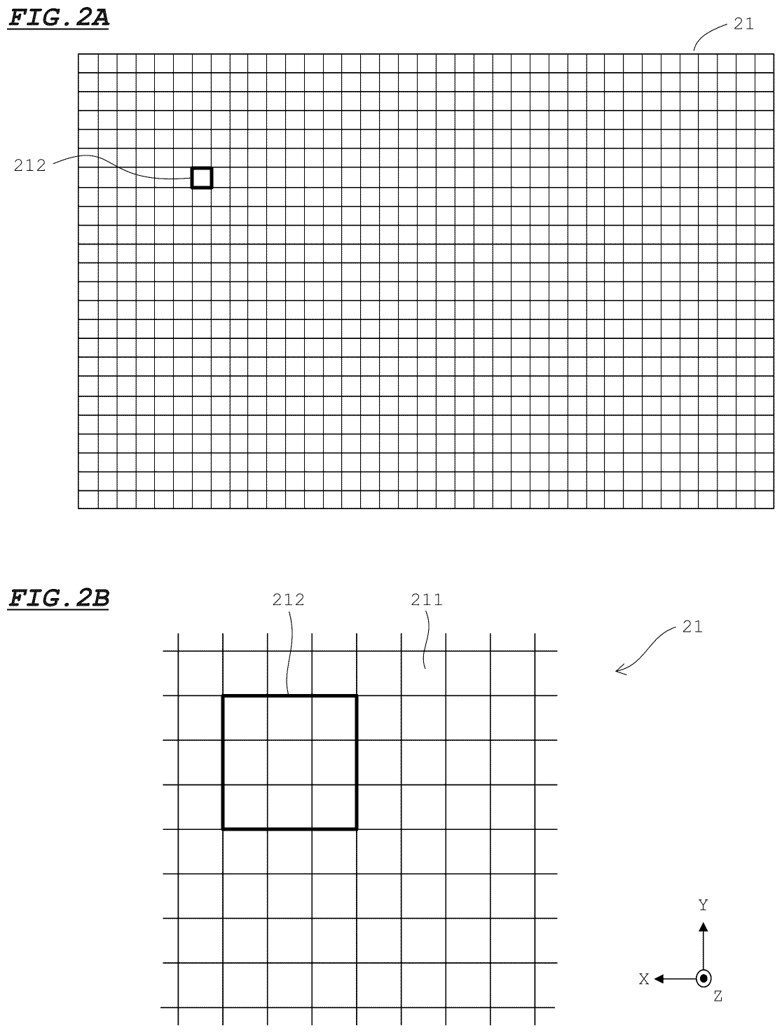

FIG. 2A and FIG. 2B are each a diagram schematically showing a method for setting a pixel block 212 for the first imaging element 21. FIG. 2A shows a method for setting the pixel block 212 for the entire imaging surface, and FIG. 2B shows a partial region of the imaging surface in an enlarged manner.

As shown in FIG. 2A and FIG. 2B, the imaging surface of the first imaging element 21 is divided into a plurality of pixel blocks 212 each including a predetermined number of pixel regions 211. Each pixel region 211 is a region corresponding to one pixel on the first imaging element 21. That is, each pixel region 211 is a smallest unit of the imaging surface. In the example in FIG. 2A and FIG. 2B, one pixel block 212 is composed of nine pixel regions 211 arranged in three rows and three columns. However, the number of pixel regions 211 included in one pixel block 212 is not limited thereto. Similarly, pixel blocks are set on the imaging surface of the second imaging element 22.

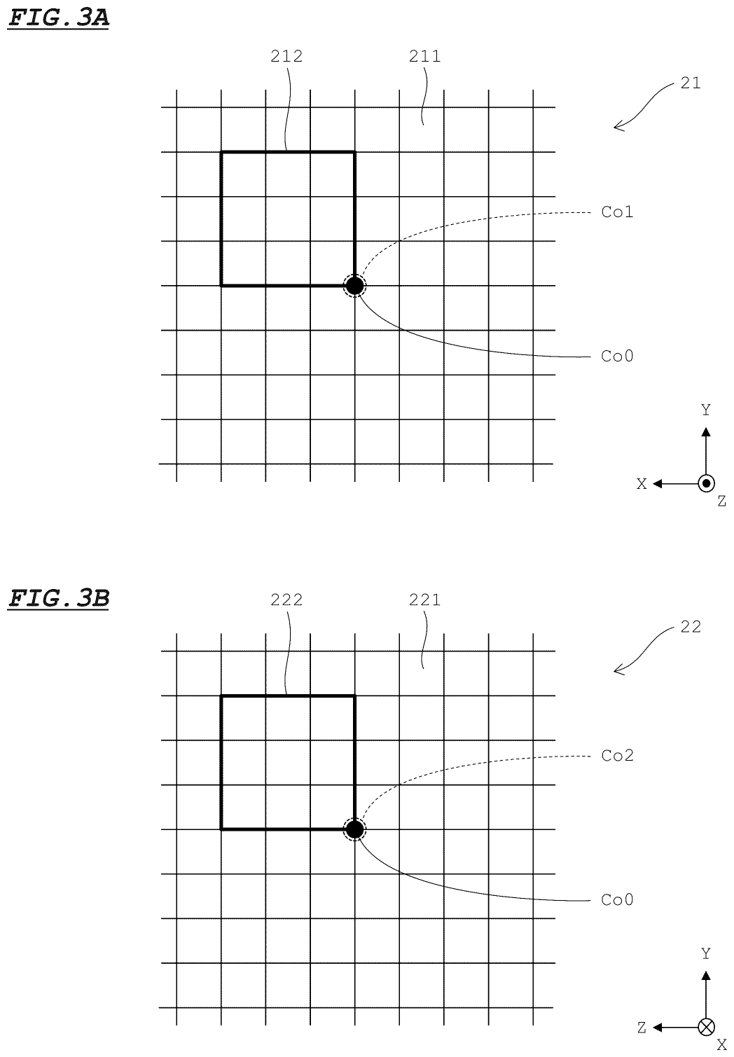

FIG. 3A and FIG. 3B are diagrams schematically showing the relationships between the optical axis of the imaging lens 24 and the imaging surfaces of the first imaging element 21 and the second imaging element 22, respectively. FIG. 3A and FIG. 3B show areas around the centers of the imaging surfaces of the first imaging element 21 and the second imaging element 22.

As shown in FIG. 3A, a center Co1 of the imaging surface of the first imaging element 21 is aligned with the optical axis center Co0 of the imaging lens 24. As shown in FIG. 3B, a center Co2 of the imaging surface of the second imaging element 22 is aligned with the optical axis center Co0 of the imaging lens 24. Therefore, the arrangement pattern of the pixel regions 211 of the first imaging element 21 with respect to the optical axis center Co0 of the imaging lens 24 and the arrangement pattern of pixel regions 221 of the second imaging element 22 with respect to the optical axis center Co0 of the imaging lens 24 are the same as each other.

FIG. 4A is a diagram showing a configuration of the first filter 41 formed on the imaging surface of the first imaging element 21. FIG. 4B is a diagram showing a configuration of the second filter 42 formed on the imaging surface of the second imaging element 22. For convenience, FIG. 4A and FIG. 4B show ranges around the upper left corners of the first filter 41 and the second filter 42, respectively.

In FIG. 4A and FIG. 4B, the pixel regions 211 and 221 on the far side of the first filter 41 and the second filter 42 are shown by broken lines, and one pixel block 212 and one pixel block 222 are shown by thick lines.

As shown in FIG. 4A, a plurality of first regions 411 and a plurality of second regions 412 are arranged in the first filter 41. The first regions 411 transmit light in the wavelength band of the pattern light projected from the projector 10 (here, the infrared wavelength band) and do not transmit light in other wavelength bands. The second regions 412 transmit light in a wavelength band that is the visible band, and do not transmit light in other wavelength bands. Therefore, the second regions 412 do not transmit light in the wavelength band of the pattern light projected from the projector 10 (here, the infrared wavelength band).

As shown in FIG. 4B, a plurality of first regions 421 and a plurality of second regions 422 are arranged in the second filter 42. The first regions 421 transmit light in the wavelength band of the pattern light projected from the projector 10 (here, the infrared wavelength band) and do not transmit light in other wavelength bands. The second regions 422 transmit light in a wavelength band that is the visible band, and do not transmit light in other wavelength bands. Therefore, the second regions 422 do not transmit light in the wavelength band of the pattern light projected from the projector 10 (here, the infrared wavelength band).

As shown in FIG. 4A and FIG. 4B, the first regions 411 and 421 and the second regions 412 and 422 both have the same size as the pixel block 212. The first regions 411 and the second regions 412 of the first filter 41 are arranged alternately in the right-left direction and the up-down direction over the entire imaging area of the first imaging element 21. The first regions 421 and the second regions 422 of the second filter 42 are arranged alternately in the right-left direction and the up-down direction over the entire imaging area of the first imaging element 21.

In the present embodiment, the arrangement pattern of the first regions 411 and the second regions 412 in the first filter 41 and the arrangement pattern of the first regions 421 and the second regions 422 in the second filter 42 are the same as each other.

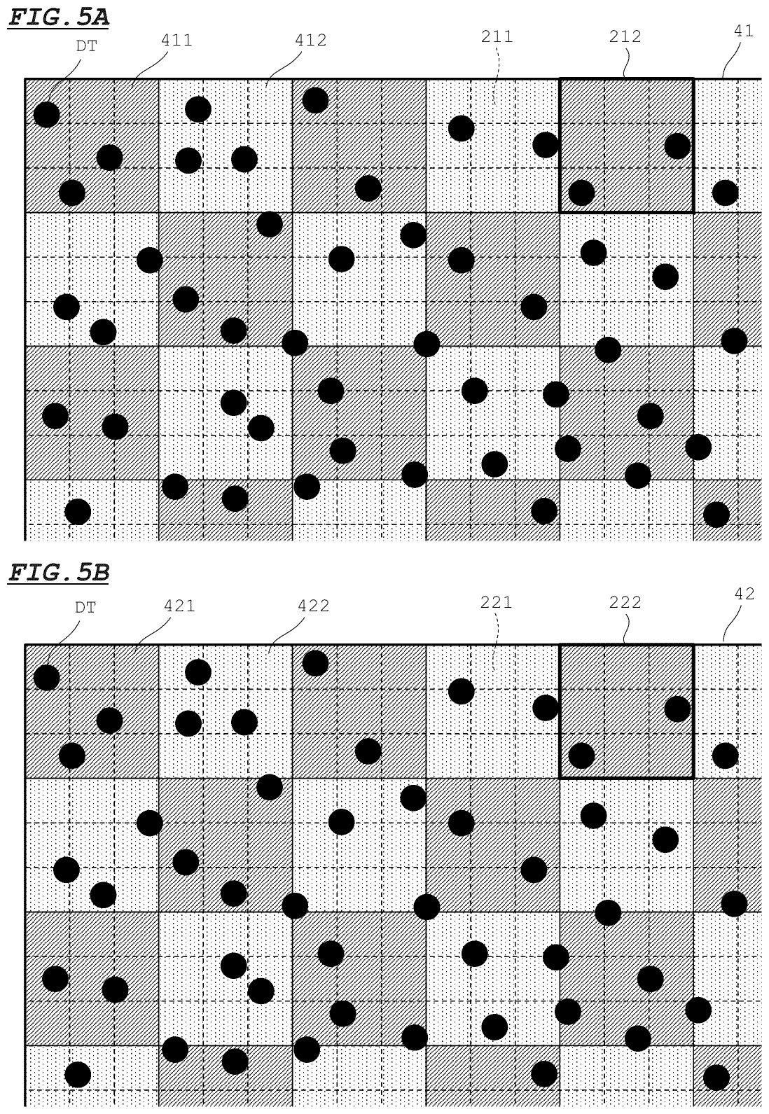

FIG. 5A and FIG. 5B are diagrams schematically showing states where the pattern light projected from the projector 10 is projected on the first filter 41 and the second filter 42, respectively.

When the pattern light is projected from the projector 10, reflected light of the pattern light reflected from the subject is received by the imaging lens 24 and condensed onto the first imaging element 21 and the second imaging element 22. Accordingly, as shown in FIG. 5A and FIG. 5B, the pattern (dots DT) of the pattern light is projected on the first filter 41 and the second filter 42 in a predetermined distribution state.

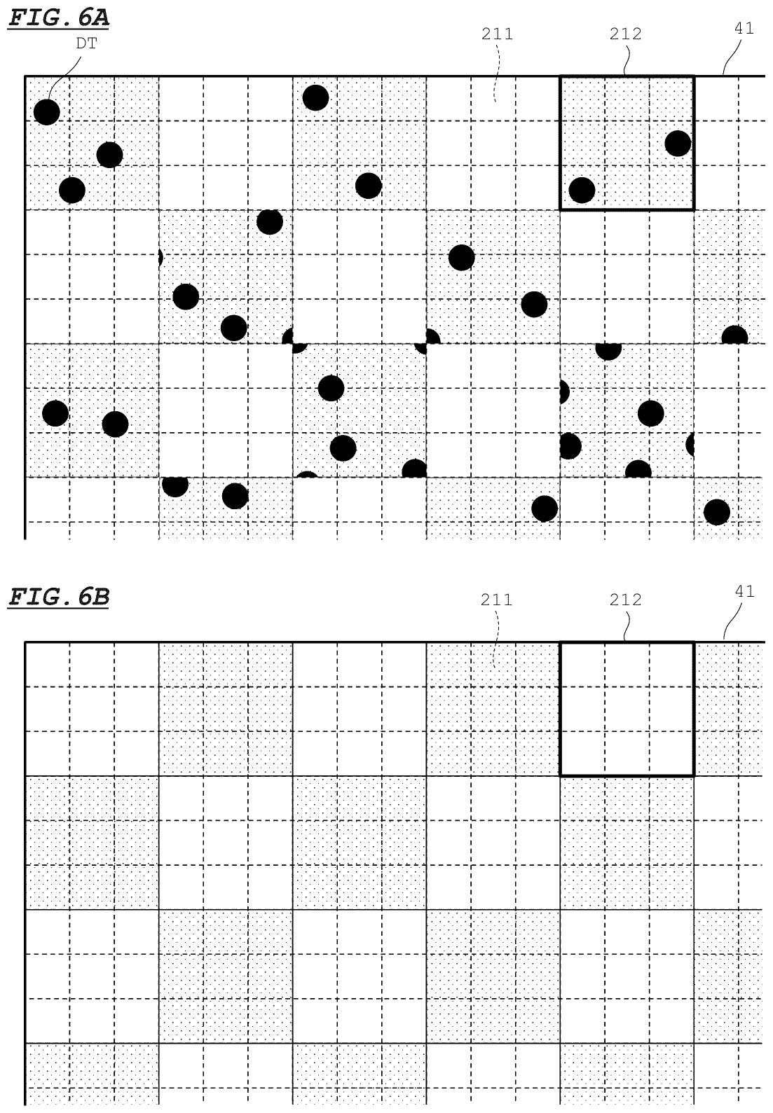

FIG. 6A and FIG. 6B are each a diagram schematically showing light incident on the imaging surface of the first imaging element 21. For convenience, in FIG. 6A, light in the infrared wavelength band passing through the first region 411 is shown by hatching. In FIG. 6B, light in the visible wavelength band passing through the second region 412 is shown by hatching.

As shown in FIG. 6A, the pattern light which is light in the infrared wavelength band is incident on the regions corresponding to the first regions 411 in FIG. 5A, and the pattern light is not incident on the regions corresponding to the second regions 412 in FIG. 5A. Meanwhile, as shown in FIG. 6B, light in the visible wavelength band is incident on the regions corresponding to the second regions 412 in FIG. 5A, and light in the visible wavelength band is not incident on the regions corresponding to the first regions 411 in FIG. 5A. Therefore, the regions on which the pattern light is incident and the regions on which visible light is incident appear alternately in the right-left direction and the up-down direction on the entire imaging surface of the first imaging element 21.

FIG. 6A and FIG. 6B show the light incident on the imaging surface of the first imaging element 21, and as in FIG. 6A and FIG. 6B, regions on which the pattern light is incident and regions on which visible light is incident also appear alternately in the right-left direction and the up-down direction on the imaging surface of the second imaging element 22.

As shown in FIG. 6A and FIG. 6B, the dots DT are projected on the regions on which the pattern light is incident. Therefore, for these regions, a distance can be properly calculated by a stereo correspondence point search.

FIG. 7A to FIG. 7D are each a diagram schematically showing a process of searching for a matching pixel block that matches a target pixel block TB1 (pixel block 212 for which a distance is to be acquired) on a captured image, on a standard image. Here, a search process of the first process for the captured image acquired by the first imaging element 21 is shown.

First, as shown in FIG. 7A, the signal processor 31 sets a search range R0 on the standard image. A start position ST1 of the search range R0 is set to a position corresponding to the target pixel block TB1 on the standard image. The search range R0 extends from the start position ST1 by a predetermined number of pixels (the number of pixels corresponding to a distance detection range) in the direction of separation between the projector 10 and the imager 20. The width in the up-down direction of the search range R0 is the same as the width in the up-down direction of the target pixel block TB1.

The signal processor 31 sets the start position ST1 as a search position. The signal processor 31 sets a reference pixel block RB1 having the same size as the target pixel block TB1, at this search position, and calculates a correlation value between the target pixel block TB1 and the reference pixel block RB1.

Here, the correlation value is acquired, for example, as a value (SAD) obtained by calculating the differences between the pixel values (luminance) for the mutually corresponding pixel regions in the target pixel block TB1 and the reference pixel block RB1 and adding up all the absolute values of the respective calculated differences. Alternatively, the correlation value may be acquired as a value (SSD) obtained by adding up all the squared values of the above differences. However, the calculation method for the correlation value is not limited to these methods, and other calculation methods may be used as long as a correlation value that serves as an index of the correlation between the target pixel block TB1 and the reference pixel block RB1 is acquired.

Then, when the process for one reference pixel block RB1 is completed, the signal processor 31 sets the next search position as shown in FIG. 7B. Specifically, the signal processor 31 sets a position shifted from the last search position in the direction to the end of the search range R0 by one pixel, as a search position this time. Then, the signal processor 31 calculates a correlation value between the reference pixel block RB1 at the search position this time and the target pixel block TB1 by the same process as above.

The signal processor 31 repeats the same process while shifting the search position in the direction to the end by one pixel. FIG. 7C shows a state where the reference pixel block RB1 is set at the search position immediately before the final search position in the search range R0, and FIG. 7D shows a state where the reference pixel block RB1 is set at the final search position in the search range R0.

Then, when the process for the final search position is completed, the signal processor 31 acquires the search position at which the correlation value is minimum, among the sequentially set search positions. Then, the signal processor 31 extracts the reference pixel block RB1 at the search position at which the minimum correlation value has been acquired, as the pixel block (matching pixel block) corresponding to the target pixel block TB1. Furthermore, the signal processor 31 acquires a pixel deviation amount of the matching pixel block with respect to the start position ST1. Then, the signal processor 31 calculates the distance to the subject by a triangulation method from the acquired pixel deviation amount and the separation distance between the projector 10 and the imager 20.

The signal processor 31 temporarily stores the calculated distance. The signal processor 31 repeats the same process for all target pixel blocks TB1 on the captured image. Thus, by the first process, the distance to the subject is temporarily stored for all the target pixel blocks TB1.

A search process of the second process for the captured image acquired by the second imaging element 22 is also the same as above. The signal processor 31 acquires the distance to the subject for all target pixel blocks TB1 by the second process, and temporarily stores the acquired distance.

In the present embodiment, as shown in FIG. 6A, the pattern light is not applied to the regions, on the imaging surface, corresponding to the second regions 412 of the first filter 41. Therefore, for the pixel blocks 212 corresponding to these regions (target pixel blocks TB1), a distance cannot be properly acquired in some cases.

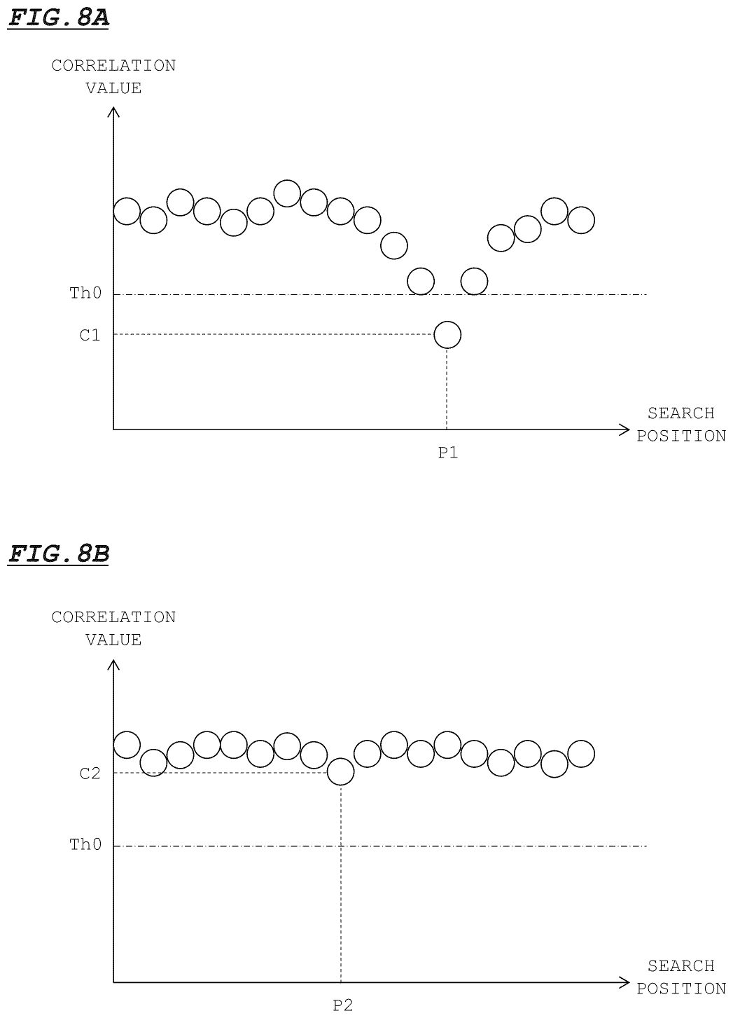

FIG. 8A is a graph illustrating the relationship between a correlation value and a search position for a target pixel block TB1 to which the pattern light is applied. FIG. 8B is a graph illustrating the relationship between a correlation value and a search position for a target pixel block TB1 to which the pattern light is not applied. Here, SAD or SSD is assumed as the correlation value on the vertical axis.

As shown in FIG. 8A, in the search process for the target pixel block TB1 to which the pattern light is applied, a correlation value C1 acquired at a search position P1 which is the position of the matching pixel block is significantly small to the extent that the correlation value C1 is clearly distinguishable from correlation values at other positions. Accordingly, the minimum correlation value C1 is acquired at the search position P1. Thus, the search position P1 is appropriately identified as the position of the matching pixel block.

On the other hand, as shown in FIG. 8B, in the search process for the target pixel block TB1 to which the pattern light is not applied, the differences between the correlation value acquired at the position of the matching pixel block and the correlation values at the other positions become smaller. Therefore, due to the influence of noise, etc., a correlation value C2 acquired at another position P2 different from the position of the matching pixel block may become a minimum value, and this position may be erroneously detected as the position of the matching pixel block.

To solve such a problem, the signal processor 31 sets a predetermined threshold value Th0 for a correlation value, and if the minimum correlation value acquired by the search process is not the threshold value Th0 or less, the signal processor 31 determines that a distance cannot be calculated for this target pixel block TB1, and performs a process for this target pixel block TB1. In this case, the signal processor 31 interpolates the distance for the target pixel block TB1 for which a distance could not be calculated, with the distances obtained for the pixel blocks surrounding the target pixel block TB1. As the method of interpolation, a well-known conventional method, such as a method using the average of the distances for the surrounding pixel blocks, can be used.

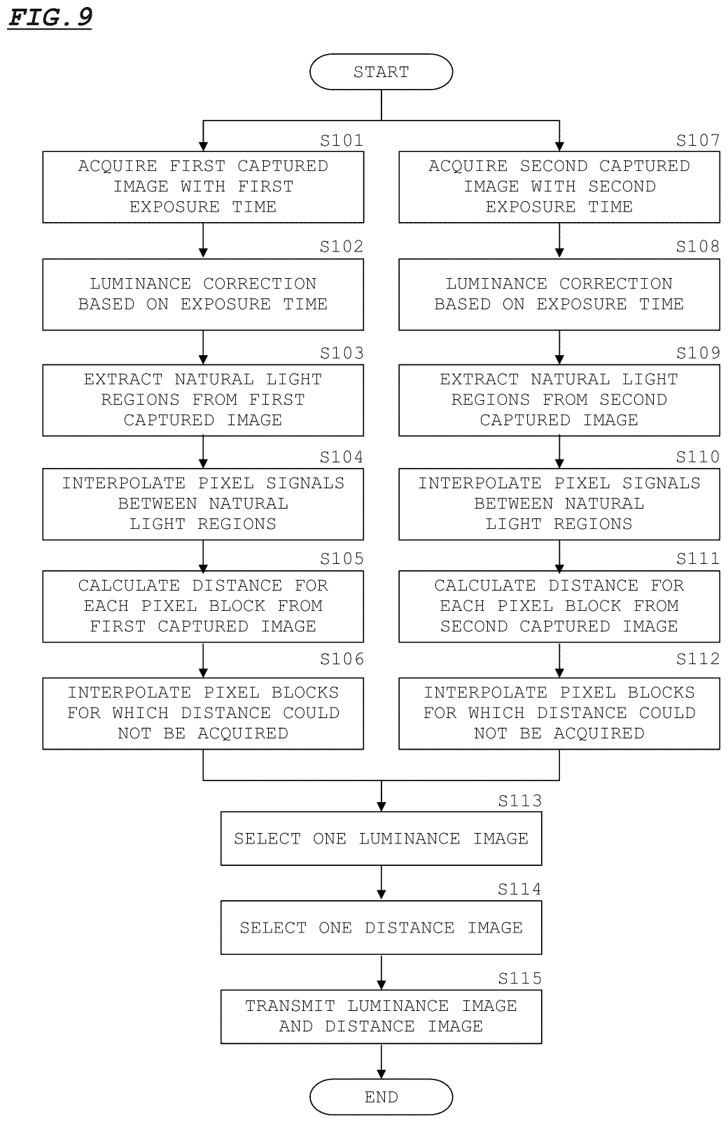

FIG. 9 is a flowchart showing a process for acquiring a distance to and an image of a subject.

In the flowchart in FIG. 9, steps S101 to S106 are a process step by the first process shown in FIG. 1, and steps S107 to S112 are a process step by the second process shown in FIG. 1.

In step S101, the signal processor 31 causes the first imaging element 21 to operate with a first exposure time to acquire a first captured image. In step S102, the signal processor 31 performs luminance correction based on the exposure time for each pixel signal of the first captured image. More specifically, the luminance correction is performed for each pixel signal of the first captured image such that the luminance level becomes a level achieved when a standard exposure time is set for the first imaging element 21.

In step S103, the signal processor 31 extracts, from the first captured image after the luminance correction, regions on which natural light (visible light) is incident, that is, the regions corresponding to the second regions 412 of the first filter 41. In step S104, the signal processor 31 interpolates pixel signals for the regions between the extracted natural light regions with pixel signals for the regions surrounding these regions, and generates an image (luminance image) of the subject for one screen.

In step S105, the signal processor 31 calculates a distance for each pixel block 212 on the first captured image by the above-described search process from the first captured image. In step S106, the signal processor 31 interpolates distances for the pixel blocks 212 for which a distance could not be acquired by the search process, with the distances for the pixel blocks surrounding these pixel blocks 212, and acquires a distance image in which distances are associated with all pixel blocks.

In step S107, the signal processor 31 causes the second imaging element 22 to operate with a second exposure time different from the first exposure time, to acquire a second captured image. For example, the second exposure time is set shorter than the first exposure time. Steps S108 to S112 and steps S102 to S106 are the same as each other in the content of the process itself, and are different from each other only in that the captured images for which the process is to be performed are the first captured image and the second captured image, respectively. By steps S108 to S112, for the second captured image, the signal processor 31 acquires an image (luminance image) of the subject and a distance image in which distances are associated with all pixel blocks.

In step S113, the signal processor 31 selects one of the images (luminance images) of the subject acquired for the first captured image and the second captured image, respectively. In step S114, the signal processor 31 selects one of the distance images acquired for the first captured image and the second captured image, respectively.

For example, when there is no defect such as a failure in both the first imaging element 21 and the second imaging element 22, the signal processor 31 selects the image (luminance image) of the subject and the distance image acquired for the first captured image (captured image for which the exposure time is longer) in steps S113 and S114. When a defect such as a failure is detected in one of the first imaging element 21 and the second imaging element 22, the signal processor 31 selects the image (luminance image) of the subject and the distance image acquired for the captured image from the imaging element in which there is no defect, in steps S113 and S114.

For example, during initial operation before executing the process in FIG. 9, detection of a failure in the first imaging element 21 and the second imaging element 22 is performed by acquiring a first captured image and a second captured image from the first imaging element 21 and the second imaging element 22 with the same exposure time while projecting the pattern light from the projector 10, and comparing the first captured image and the second captured image.

For example, when the pixel signals of the pixels, of the first captured image and the second captured image, corresponding to each other are substantially the same for all pixels, it is determined that there is no defect such as a failure in the first imaging element 21 and the second imaging element 22. On the other hand, when one of the pixel signals of pixels corresponding to each other tends to be lower than the other, it is determined that there is a defect such as a failure in the imaging element from which the one of the pixel signals is acquired.

However, the method of determining a failure is not limited thereto. For example, the average value of pixel signals may be acquired from each of the first captured image and the second captured image acquired during initial operation, and the acquired average values may be compared to determine the presence or absence of a failure in the first captured image and the second captured image. In this case, when these average values are substantially the same, it is determined that there is no failure in the first captured image and the second captured image, and when one of these average values is lower than the other, it is determined that there is a defect such as a failure in the imaging element from which the one of these average values is acquired.

Alternatively, from the first captured image and the second captured image for several frames acquired during initial operation, the variation of each pixel value of the first captured image and the variation of each pixel value of the second captured image may be monitored, and when the variation of the pixel values of any of the first imaging element 21 and the second imaging element 22 exceeds a threshold range, it may be determined that there is a defect in that imaging element.

When there is no defect such as a failure in both the first imaging element 21 and the second imaging element 22, one of the luminance images and one of the distance images acquired for the first captured image and the second captured image, respectively, may be selected based on the reflectance or the light absorption rate of the subject. For example, when the reflectance for infrared light is high, the signal processor 31 may select the distance image acquired from the second captured image for which the exposure time is shorter, in step S114.

Alternatively, representative values (e.g., average values, median values, etc.) of pixel signals may be obtained from a predetermined region in the first captured image and a predetermined region in the second captured image, and the luminance image and the distance image acquired from the captured image whose representative value is closer to a preset value, may be selected in step S114.

In step S115, the signal processor 31 transmits the image (luminance image) of the subject and the distance image selected in steps S113 and S114 to the external device via the communication interface 35. Then, the signal processor 31 ends the process in FIG. 9.

### Effects of Embodiment

According to the above embodiment, the following effects are achieved.

As shown in FIG. 1, the light from the subject is guided to the first imaging element 21 and the second imaging element 22 by the light-splitting element 23. Therefore, as shown in FIG. 9, based on each of the first captured image and the second captured image acquired by the first imaging element 21 and the second imaging element 22, respectively, an image of the subject can be captured and the distance to the subject can be calculated. At this time, since the first exposure time for the first imaging element 21 and the second exposure time for the second imaging element 22 are different from each other, the image capture and distance calculation can be performed in the range of light intensity corresponding to each exposure time. Accordingly, the range (dynamic range) over which image capture and distance calculation can be performed can be expanded. In addition, even if a defect such as a failure occurs in any one of the imaging elements, the distance to the subject can be calculated using the captured image from the other imaging element. Therefore, the calculation of the distance to the subject can be prevented from becoming impossible.

As described with reference to FIG. 6B, the pattern light is removed by the second regions 412 of the first filter 41 and the second regions 422 of the second filter 42, so that a luminance image of the subject in which the pattern light is not seen can be generated using pixel signals from pixels in a range where the light passing through the second regions 412 and 422 is received. Accordingly, the calculation of the distance to the subject and the generation of a luminance image of the subject can be realized simultaneously.

As shown in FIG. 4A and FIG. 4B, the arrangement pattern of the first regions 411 and the second regions 412 in the first filter 41 and the arrangement pattern of the first regions 421 and the second regions 422 in the second filter 42 are the same as each other. Accordingly, the processes of creating luminance images and distance images for the first captured image and the second captured image (first process and second process) can be the same. Therefore, the processing in the signal processor 31 can be simplified.

As shown in FIG. 4A and FIG. 4B, the first regions 411 and the second regions 412 are alternately arranged in the first filter 41, and the first regions 421 and the second regions 422 are alternately arranged in the second filter 42. Accordingly, as shown in FIG. 6A and FIG. 6B, in the first captured image and the second captured image, regions where a luminance image and a distance image are acquired exist in regions adjacent to the upper, lower, left, and right sides of regions where a luminance image and a distance image cannot be acquired. Therefore, interpolation for the regions where a luminance image and a distance image cannot be acquired can be smoothly and appropriately performed.

As shown in FIG. 4A and FIG. 4B, each of the first regions 411 and 421 is set with a size that is an integer multiple (here, one time) of the pixel block 212 or 222 which is a smallest unit of distance detection. Accordingly, as shown in FIG. 6A, the pixel blocks 212 and 222 at the positions corresponding to the first regions 411 and 421 include all pattern (dots DT) of the pattern light that should originally be included. Therefore, a stereo correspondence point search for these pixel blocks 212 and 222 can be accurately performed, and as a result, distance calculation for these pixel blocks 212 and 222 can be accurately performed. In addition, since the accuracy of distance calculation for these pixel blocks 212 and 222 is high, distance interpolation for pixel blocks adjacent to the pixel blocks 212 and 222 can also be accurately performed.

As shown in FIG. 3A and FIG. 3B, the arrangement pattern of the pixel regions 211 of the first imaging element 21 with respect to the optical axis center Co0 of the imaging lens 24 and the arrangement pattern of the pixel regions 221 of the second imaging element 22 with respect to the optical axis center Co0 of the imaging lens 24 are the same as each other. Accordingly, the processes of creating luminance images and distance images for the first captured image and the second captured image (first process and second process) can be the same. Therefore, the processing in the signal processor 31 can be simplified.

As described above, the wavelength band transmitted through the first regions 411 and 421 (first wavelength band) is a wavelength band included in the infrared band (non-visible band), and a second wavelength band transmitted through the second regions 412 and 422 is a wavelength band included in the visible band. Accordingly, a luminance image of the subject can be acquired by natural light (visible light) from the subject while the distance to the subject is acquired by applying infrared (non-visible) pattern light to the subject.

In steps S113 and S114 in FIG. 9, the signal processor 31 selects one of the luminance images and one of the distance images acquired by the first process and the second process, respectively, according to a predetermined selection condition including the presence or absence of a failure in the first imaging element 21 and the second imaging element 22 and the reflectance and the light absorption rate of the subject. Accordingly, the luminance image of the subject and the distance image can be acquired smoothly and appropriately in accordance with a failure and the state of the subject.

### <Modification 1>

In the above embodiment, as shown in FIG. 4A and FIG. 4B, the arrangement pattern of the first regions 411 and the second regions 412 in the first filter 41 and the arrangement pattern of the first regions 421 and the second regions 422 in the second filter 42 are the same as each other. In contrast, in Modification 1, the arrangement pattern of the first regions 411 and the second regions 412 in the first filter 41 and the arrangement pattern of the first regions 421 and the second regions 422 in the second filter 42 are different from each other.

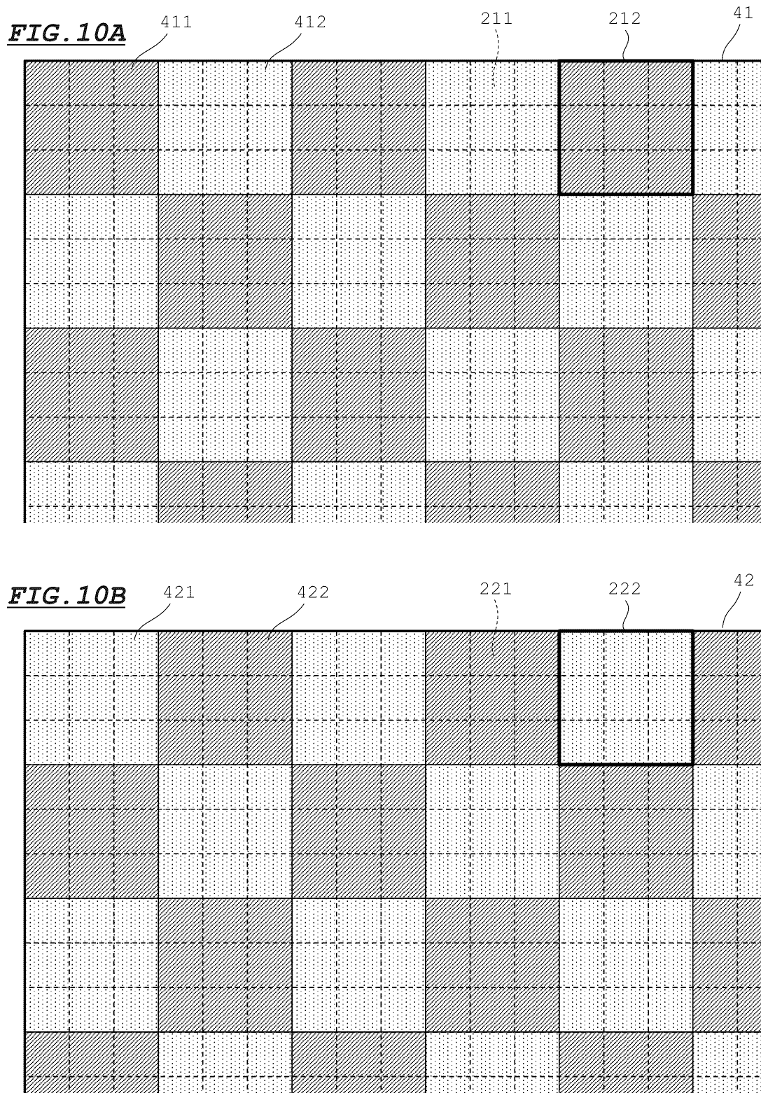

FIG. 10A is a diagram showing a configuration of a first filter 41 formed on the imaging surface of a first imaging element 21 according to Modification 1. FIG. 10B is a diagram showing a configuration of a second filter 42 formed on the imaging surface of a second imaging element 22 according to Modification 1. Similar to FIG. 4A and FIG. 4B, FIG. 10A and FIG. 10B show ranges around the upper left corners of the first filter 41 and the second filter 42, respectively.

As shown in FIG. 10A and FIG. 10B, in Modification 1, the first regions 411 and the second regions 412 of the first filter 41 and the first regions 421 and the second regions 422 of the second filter 42 are interchanged with each other. That is, the second regions 422 and the first regions 421 are arranged in the second filter 42 at the regions where the first regions 411 and the second regions 412 are arranged, respectively, in the first filter 41. The sizes of the first regions 411 and 421 and the second regions 412 and 422 are the same as those of the pixel blocks 212 and 222 as in the above embodiment.

Even with the configuration in FIG. 10A and FIG. 10B, a luminance image of a subject and a distance image can be acquired from a first captured image by the first process (S101 to S106) in FIG. 9, and a luminance image of the subject and a distance image can be acquired from a second captured image by the second process (S107 to S112). In addition, either the luminance image and the distance image acquired from the first captured image or the luminance image and the distance image acquired from the second captured image can be selected and transmitted to an external device.

In the configuration of Modification 1, as shown in FIG. 10A and FIG. 10B, the first regions 411 and the second regions 412 of the first filter 41 and the first regions 421 and the second regions 422 of the second filter 42 are interchanged with each other. Therefore, natural light is applied to regions, on the second captured image, corresponding to regions, on the first captured image, to which no natural light is applied. Therefore, a luminance image for one frame can be generated by superimposing an image for one frame generated by extracting only the regions to which natural light is applied, from the first captured image, and an image for one frame generated by extracting only the regions to which natural light is applied, from the second captured image, on each other. That is, in the configuration of Modification 1, by superimposing such images, a luminance image for one frame can be acquired without performing an interpolation process.

As for the distance image, similarly, a distance image for one frame can be generated by superimposing a distance image for one frame including only distances acquired for the pixel blocks corresponding to the first regions 411 on the first captured image, and a distance image for one frame including only distances acquired for the pixel blocks corresponding to the first regions 421 on the second captured image, on each other. That is, in the configuration of Modification 1, by superimposing such distance images, a distance image for one frame can be acquired without performing an interpolation process.

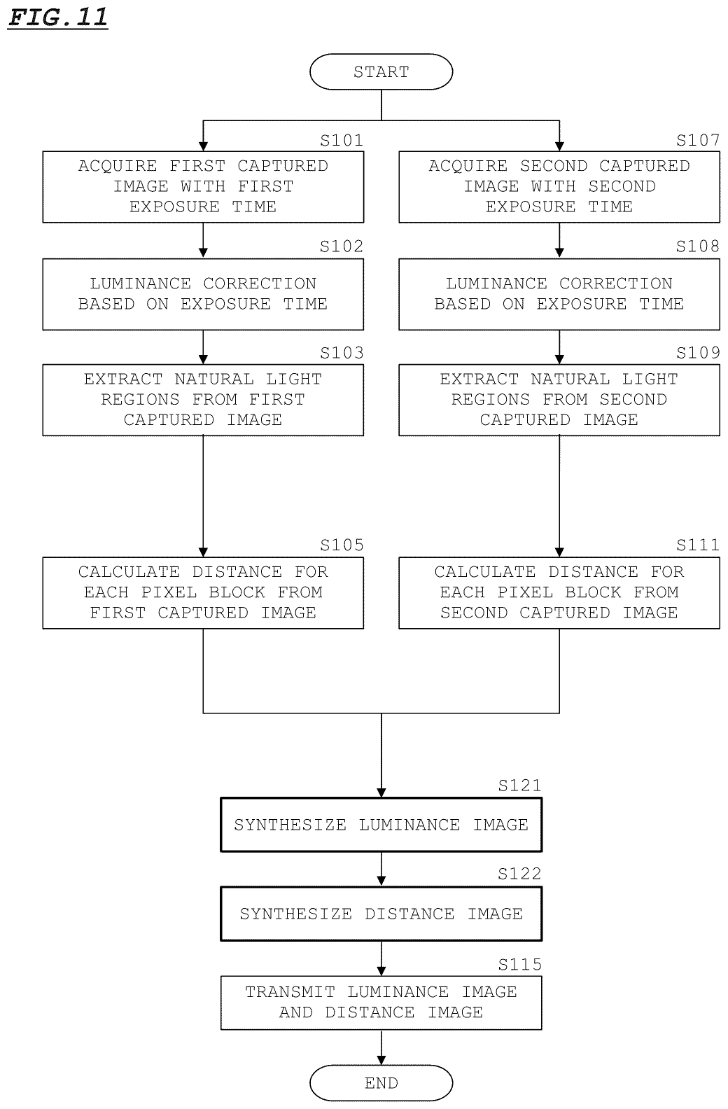

FIG. 11 is a flowchart showing a process for acquiring a distance and an image when the filter configuration of Modification 1 is used.

In the flowchart in FIG. 11, the interpolation process in steps S104, S106, S110, and S112 in FIG. 9 is omitted, and steps S113 and S114 in FIG. 9 are replaced by steps S121 and S122.

In step S121, the signal processor 31 generates a luminance image for one frame by combining a luminance image including only the natural light regions extracted in step S103 and a luminance image including only the natural light regions extracted in step S109. More specifically, the signal processor 31 generates a luminance image for one frame by embedding the pixel signals (luminance) of the respective pixels in the regions extracted in step S109 into the regions not extracted in step S103.

In step S122, the signal processor 31 generates a distance image for one frame by combining a distance image including only distances corresponding to the pixel blocks for which a distance is calculated in step S105 and a distance image including only distances corresponding to the pixel blocks for which a distance is calculated in step S111. More specifically, the signal processor 31 generates a distance image for one frame by embedding the distances at the positions of the pixel blocks for which a distance is calculated in step S111, that is, the positions corresponding to the first regions 421 of the second filter 42, into the positions of the pixel blocks for which a distance is not calculated in step S105, that is, the positions corresponding to the second regions 412 of the first filter 41.

In step S115, the signal processor 31 transmits the luminance image generated in step S121 and the distance image generated in step S122 to the external device via the communication interface 35.

With the configuration of Modification 1, by the process in FIG. 11, a luminance image and a distance image can be generated without performing interpolation. Therefore, the processing in the signal processor 31 can be simplified.

If a distance could not be calculated for some pixel blocks in the distance image synthesized in step S122 in FIG. 11, an interpolation process may be performed for these pixel blocks.

### <Modification 2>

In the above embodiment, the pattern light in one type of wavelength band is projected from the projector 10, but pattern lights in a plurality of types of wavelength bands may be projected from the projector 10 and applied to a subject.

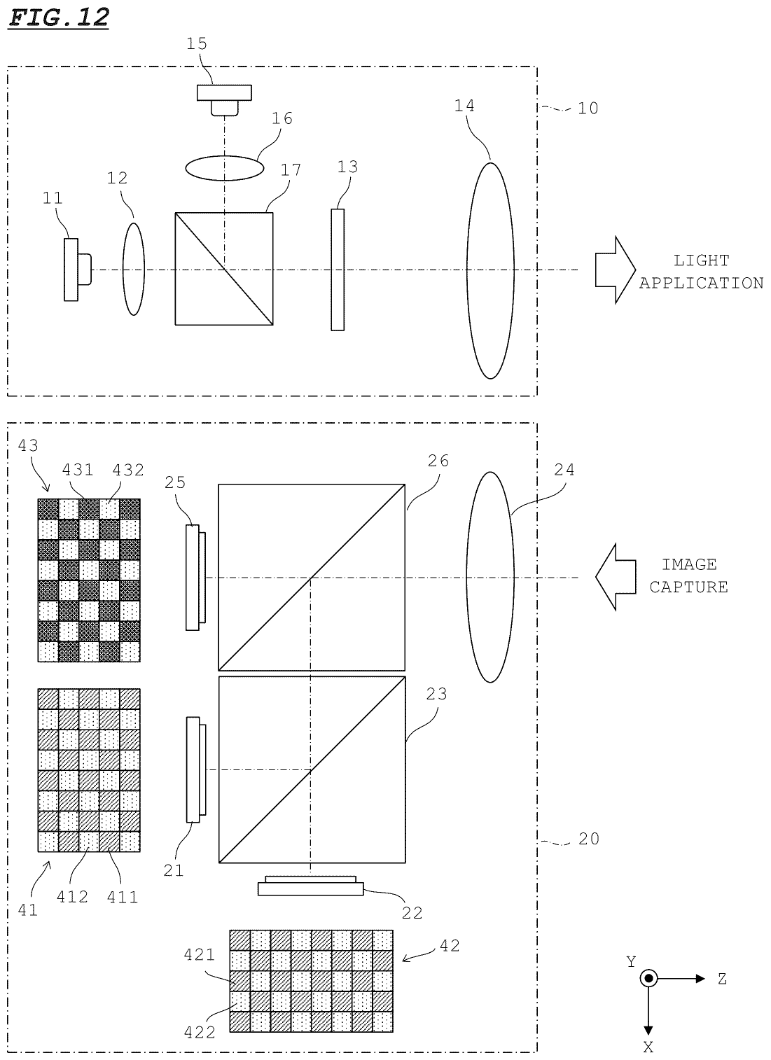

FIG. 12 is a diagram showing configurations of a projector 10 and an imager 20 according to Modification 2.

The projector 10 includes a light source 15, a collimator lens 16, and a combining element 17 in addition to the configuration shown in FIG. 1.

The light source 15 emits light in a wavelength band different from that of the light source 11. The light source 15 is, for example, a semiconductor laser. The light source 15 may be another type of light source such as an LED (Light Emitting Diode). The emission wavelength of the light source 15 is, for example, included in the infrared wavelength band. The emission wavelength of the light source 15 may be included in the visible wavelength band. The collimator lens 16 converts the light emitted from the light source 15, into substantially collimated light.

The combining element 17 aligns the optical axis of the light source 11 and the optical axis of the light source 15 with each other. The combining element 17 transmits the light from the light source 11 and reflects the light from the light source 15. The combining element 17 is, for example, a dichroic mirror. When the light sources 11 and 15 are semiconductor lasers, the combining element 17 may be a polarizing beam splitter. In this case, the light source 11 is placed such that a polarization direction is a P-polarization direction with respect to the combining element 17, and the light source 15 is placed such that a polarization direction is an S-polarization direction with respect to the combining element 17.

The pattern generator 13 generates pattern lights for both the light emitted from the light source 11 and the light emitted from the light source 15, respectively. As in the above embodiment, the pattern generator 13 can be composed of a transmission-type diffractive optical element (DOE). The pattern light in each wavelength band is projected onto a subject by the projection lens 14.

The imager 20 includes a third imaging element 25 and a light-splitting element 26 in addition to the configuration shown in FIG. 1. A third filter 43 is formed on the imaging surface of the third imaging element 25. A plurality of first regions 431 and a plurality of second regions 432 are alternately arranged in the third filter 43. The arrangement pattern of the first regions 431 and the second regions 432 may be the same as the arrangement pattern of the first regions 411 and the second regions 412 in the first filter 41 shown in FIG. 10A, or may be the same as the arrangement pattern of the first regions 421 and the second regions 422 in the second filter 42 shown in FIG. 10B.

The first regions 431 of the third filter 43 transmit light in the emission wavelength band of the light source 15 and do not transmit light in other wavelength bands. The second regions 432 of the third filter 43 transmit light in the visible light wavelength band and do not transmit light in other wavelength bands. Therefore, the second regions 432 do not transmit light in the emission wavelength bands of the light sources 11 and 15.

As described above, the first regions 411 and 421 of the first filter 41 and the second filter 42 transmit light in the emission wavelength band of the light source 11 and do not transmit light in other wavelength bands, and thus do not transmit light in not only the visible light wavelength band but also the emission wavelength band of the light source 15. In addition, as described above, the second regions 412 and 422 of the first filter 41 and the second filter 42 transmit light in the visible light band and do not transmit light in other wavelength bands, and thus do not transmit not only light in the emission wavelength band of the light source 11 but also light in the emission wavelength band of the light source 15.

The light-splitting element 26 splits light incident from the imaging lens 24 side to the third imaging element 25 and the light-splitting element 23. The light-splitting element 26 is, for example, a half mirror. The light-splitting element 26 may be a diffractive optical element.

In the configuration in FIG. 12, due to the difference between the optical path length between the imaging lens 24 and the imaging surface of the third imaging element 25 and the optical path lengths between the imaging lens 24 and the imaging surfaces of the first imaging element 21 and the second imaging element 22, image formation states of the subject on the imaging surfaces of the first imaging element 21 and the second imaging element 22 are slightly different from an image formation state of the subject on the imaging surface of the third imaging element 25. To eliminate this problem, a relay lens may be further placed between the light-splitting elements 23 and 26.

In the configuration in FIG. 12, a third imaging processor for the third imaging element 25 is provided in addition to the first imaging processor 33 and the second imaging processor 34 shown in FIG. 1. The third imaging processor controls the third imaging element 25 and performs processing such as luminance correction and camera calibration on pixel signals of a captured image outputted from the third imaging element 25. The signal processor 31 further generates a luminance image and a distance image using a third captured image acquired from the third imaging element 25.

That is, the signal processor 31 exposes the third imaging element 25 for a predetermined time to acquire the third captured image. The exposure time for the third imaging element 25 may be the same as either one of the first exposure time for the first imaging element 21 and the second exposure time for the second imaging element 22, or may be different from the first exposure time and the second exposure time.

The signal processor 31 executes the same process as in steps S102 to S106 in FIG. 9 on the acquired third captured image to generate a luminance image and a distance image. In this case, the signal processor 31 may store a standard image for performing a stereo correspondence point search for the third captured image, separately from a standard image for performing a stereo correspondence point search for a first captured image and a second captured image. The signal processor 31 executes the same process as above, using the third captured image acquired from the third imaging element 25, along with the process in FIG. 9.

With this configuration, in addition to the first captured image and the second captured image, a luminance image of the subject and a distance image can also be acquired from the third captured image. Therefore, even if a defect such as a failure occurs in both the first imaging element 21 and the second imaging element 22, the luminance image and the distance image acquired from the third captured image can be provided to an external device.

Since the wavelength bands transmitted through the first regions 431 of the third filter 43 and the first regions 411 and 421 of the first filter 41 and the second filter 42 are different from each other, when the reflectance of the subject differs in these wavelength bands, the intensity of the pattern light received by the first imaging element 21 and the second imaging element 22 and the intensity of the pattern light received by the third imaging element 25 are different from each other. Therefore, in this case, the distance image acquired for the imaging element in which the intensity of the pattern light received is higher may be selected and transmitted to the external device. Accordingly, a distance image having a higher quality can be provided to the external device.

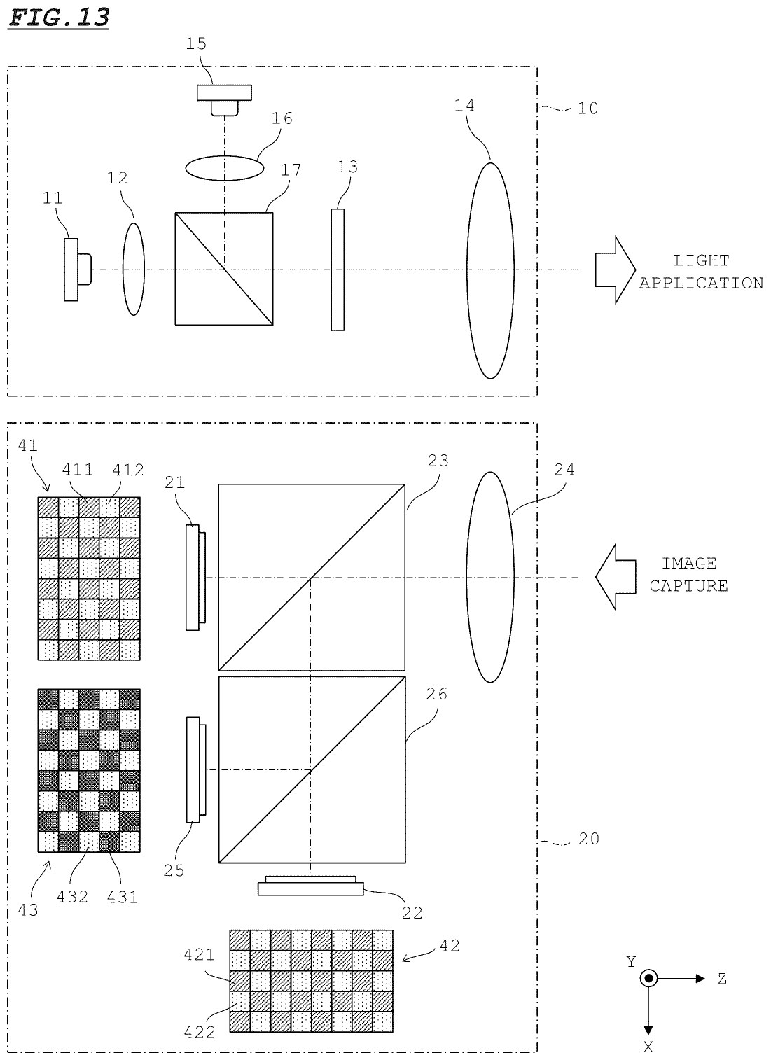

As shown in FIG. 13, the arrangement of the first imaging element 21 and the light-splitting element 23 and the arrangement of the third imaging element 25 and the light-splitting element 26 may be interchanged with each other. In this configuration, due to light split by the light-splitting element 26, the intensity of the light received by the imaging lens 24 and guided to the second imaging element 22 is half the intensity of the light received by the imaging lens 24 and guided to the first imaging element 21. Therefore, in this configuration, even if the first exposure time for the first imaging element 21 and the second exposure time for the second imaging element 22 are set to be the same, the range of light intensity (dynamic range) over which image capture and distance calculation can be performed by the imaging device 1 can be expanded due to this difference in light intensity.

### <Modification 3>

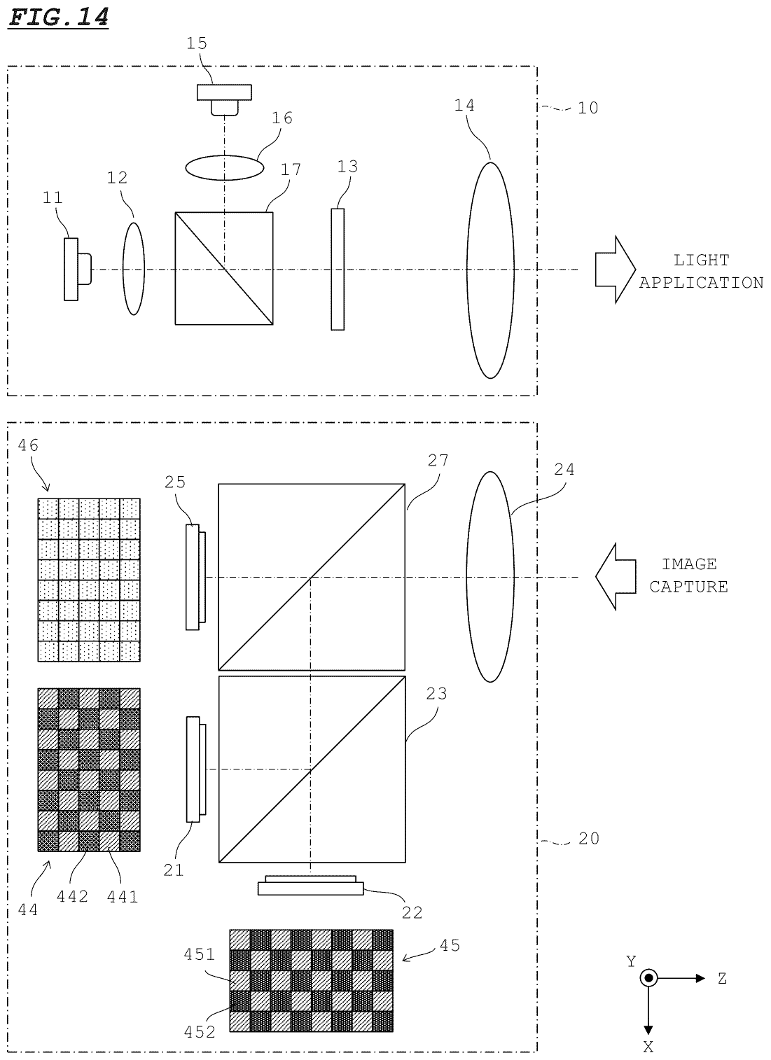

FIG. 14 is a diagram showing configurations of a projector 10 and an imager 20 according to Modification 3.

In the configuration in FIG. 14, the light-splitting element 26 in the configuration in FIG. 12 is replaced by a light-splitting element 27. The light-splitting element 27 is a dichroic mirror. The light-splitting element 27 transmits light in the visible light wavelength band, of the light received by the imaging lens 24, and reflects light in other wavelength bands. Therefore, the light in the visible light wavelength band, of the light received by the imaging lens 24, is guided to the third imaging element 25, and the light in the other wavelength bands is further split and guided to the first imaging element 21 and the second imaging element 22 by the light-splitting element 23.

On the imaging surfaces of the first imaging element 21 and the second imaging element 22, a first filter 44 and a second filter 45 are formed instead of the first filter 41 and the second filter 42 described in the above embodiment. A plurality of first regions 441 and a plurality of second regions 442 are arranged in the first filter 44, and a plurality of first regions 451 and a plurality of second regions 452 are arranged in the second filter 45.

The first regions 441 and 451 transmit light in the emission wavelength band of the light source 11 and do not transmit light in other wavelength bands. The second regions 442 and 452 transmit light in the emission wavelength band of the light source 15 and do not transmit light in other wavelength bands. The arrangement pattern of the plurality of first regions 441 and the plurality of second regions 442 in the first filter 44 may be the same as in FIG. 4A. The arrangement pattern of the plurality of first regions 451 and the plurality of second regions 452 in the second filter 45 may be the same as in FIG. 4B or FIG. 10B.

On the imaging surface of the third imaging element 25, a third filter 46 is formed instead of the third filter 43 in FIG. 12. The third filter 46 transmits light in the wavelength band transmitted through the light-splitting element 27 (dichroic mirror) over the entire range, and does not transmit light in other wavelength bands. Therefore, from the output from the third imaging element 25, a luminance image of visible light for one frame in which the pattern light is not seen is generated as it is.

The pattern light generated from the light from the light source 11 is incident on the regions corresponding to the first regions 441 of the first imaging element 21, and the pattern light generated from the light from the light source 15 is incident on the regions corresponding to the second regions 442 of the first imaging element 21. Therefore, the signal processor 31 can generate a distance image based on the two types of lights from a first captured image of the first imaging element 21. Similarly, the signal processor 31 can generate a distance image based on the two types of lights from a second captured image of the second imaging element 22.

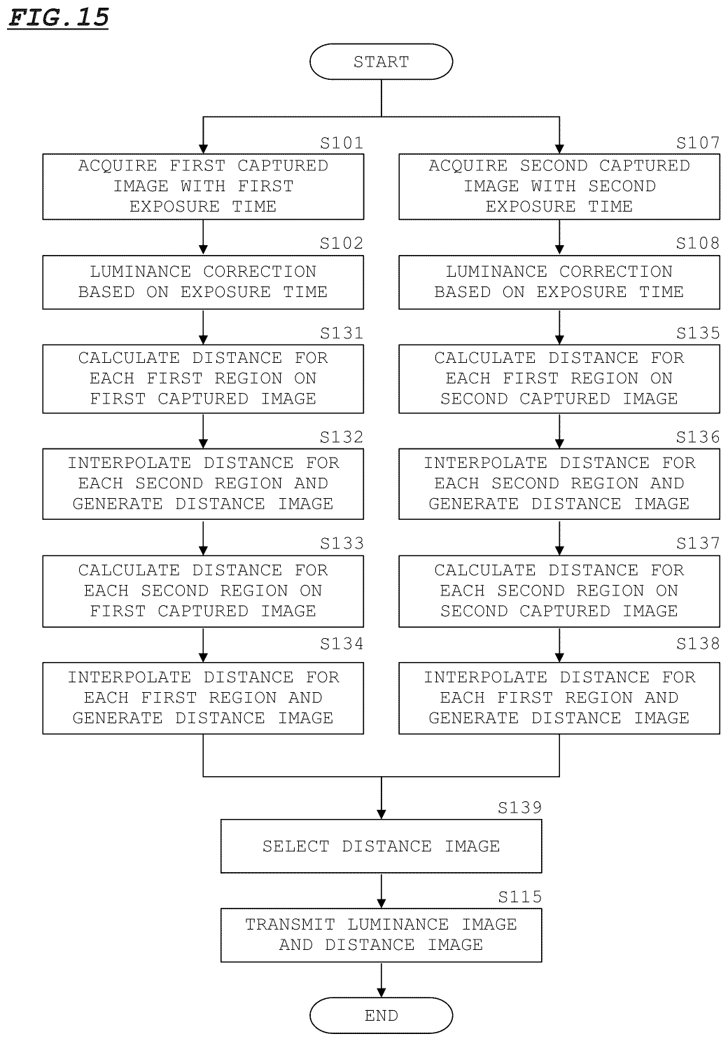

FIG. 15 is a flowchart showing a process for generating a distance image according to Modification 3.

Steps S101, S102, S107, S108, and S115 in FIG. 15 are the same as the corresponding steps in FIG. 9.

The signal processor 31 calculates a distance by a stereo correspondence point search with respect to the regions corresponding to the first regions 441 for the first captured image acquired by the first imaging element 21 (S131). The signal processor 31 performs interpolation based on the distance calculated in step S131 for the regions corresponding to the second regions 442, and generates a distance image for one frame based on the light from the light source 11 (S132).

Furthermore, the signal processor 31 calculates a distance by a stereo correspondence point search with respect to the regions corresponding to the second regions 442 for the first captured image (S133). The signal processor 31 performs interpolation based on the distance calculated in step S133 for the regions corresponding to the first regions 441, and generates a distance image for one frame based on the light from the light source 15 (S134).

Moreover, the signal processor 31 calculates a distance by a stereo correspondence point search with respect to the regions corresponding to the first regions 451 for the second captured image acquired by the second imaging element 22 (S135). The signal processor 31 performs interpolation based on the distance calculated in step S135 for the regions corresponding to the second regions 452, and generates a distance image for one frame based on the light from the light source 11 (S136).

Furthermore, the signal processor 31 calculates a distance by a stereo correspondence point search with respect to the regions corresponding to the second regions 452 for the second captured image (S137). The signal processor 31 performs interpolation based on the distance calculated in step S137 for the regions corresponding to the first regions 451, and generates a distance image for one frame based on the light from the light source 15 (S138).

Due to the above process, the two types of distance images based on the two types of lights from the light sources 11 and 15 are acquired with the first exposure time, and the two types of distance images based on the two types of lights from the light sources 11 and 15 are acquired with the second exposure time. As in the above embodiment, the signal processor 31 selects one of these distance images based on the presence or absence of a failure or the like in the first imaging element 21 and the second imaging element 22 (S139). At this time, the signal processor 31 may further select the distance image acquired using light in a wavelength band for which the reflectance of a subject is higher.

The signal processor 31 transmits the distance image thus selected, together with the luminance image acquired from a third captured image of the third imaging element 25, to an external device (S115). Then, the signal processor 31 ends the process in FIG. 15.

With this configuration, as in the above embodiment, since the exposure times for the first imaging element 21 and the second imaging element 22 are different from each other, the dynamic range of distance detection based on the light from the light source 11 can be expanded, and the dynamic range of distance detection based on the light from the light source 15 can be expanded.

Also in this configuration, even if a defect such as a failure occurs in either one of the first imaging element 21 and the second imaging element 22, a distance image can be acquired using the captured image from the other imaging element. Furthermore, since distance images can be acquired using two types of lights corresponding to the emission wavelength bands of the light sources 11 and 15, a highly accurate distance image can be provided to the external device by selecting the distance image acquired using the light in the wavelength band for which the reflectance of the subject is higher.

### <Modification 4>

In the above embodiment, the sizes of the first regions 411 and the second regions 412 of the first filter 41 and the sizes of the first regions 421 and the second regions 422 of the second filter 42 are the same as the sizes of the pixel blocks 212 and 222, but the sizes of the first regions 411 and 421 and the second regions 412 and 422 do not necessarily have to be the same as those of the pixel blocks 212 and 222.

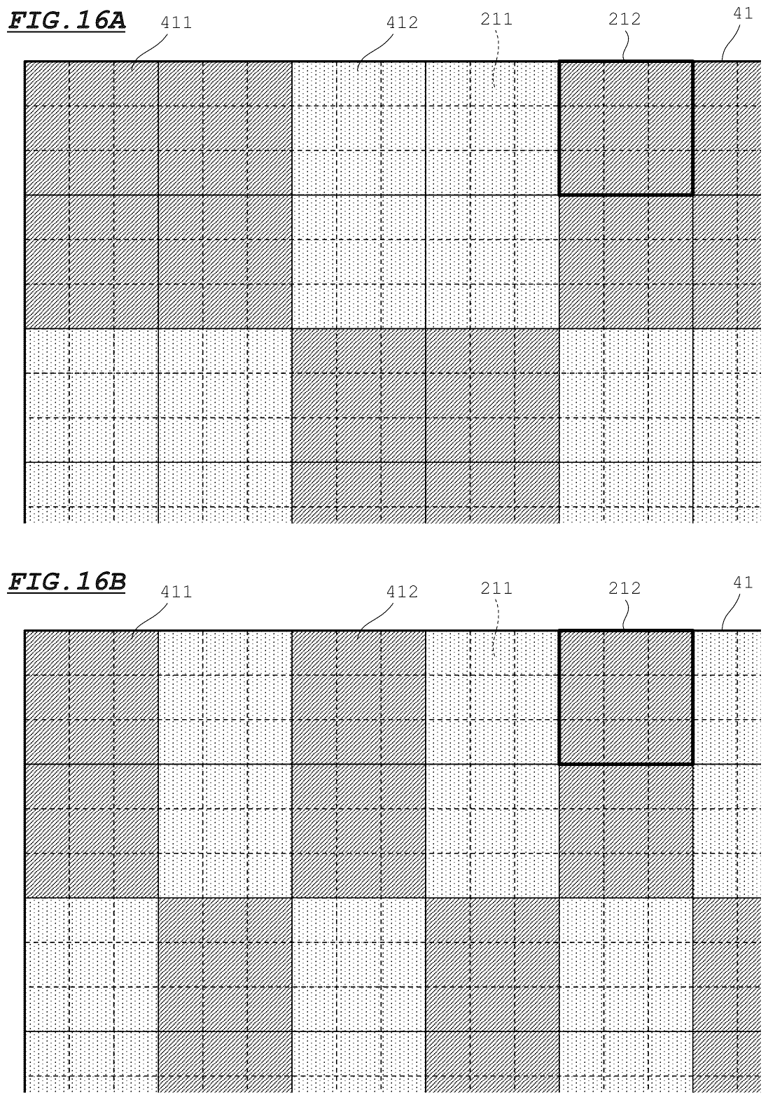

For example, as shown in FIG. 16A, the sizes of the first regions 411 and 421 and the second regions 412 and 422 may be four times the sizes of the pixel blocks 212 and 222, or as shown in FIG. 16B, the sizes of the first regions 411 and 421 and the second regions 412 and 422 may be twice the sizes of the pixel blocks 212 and 222.

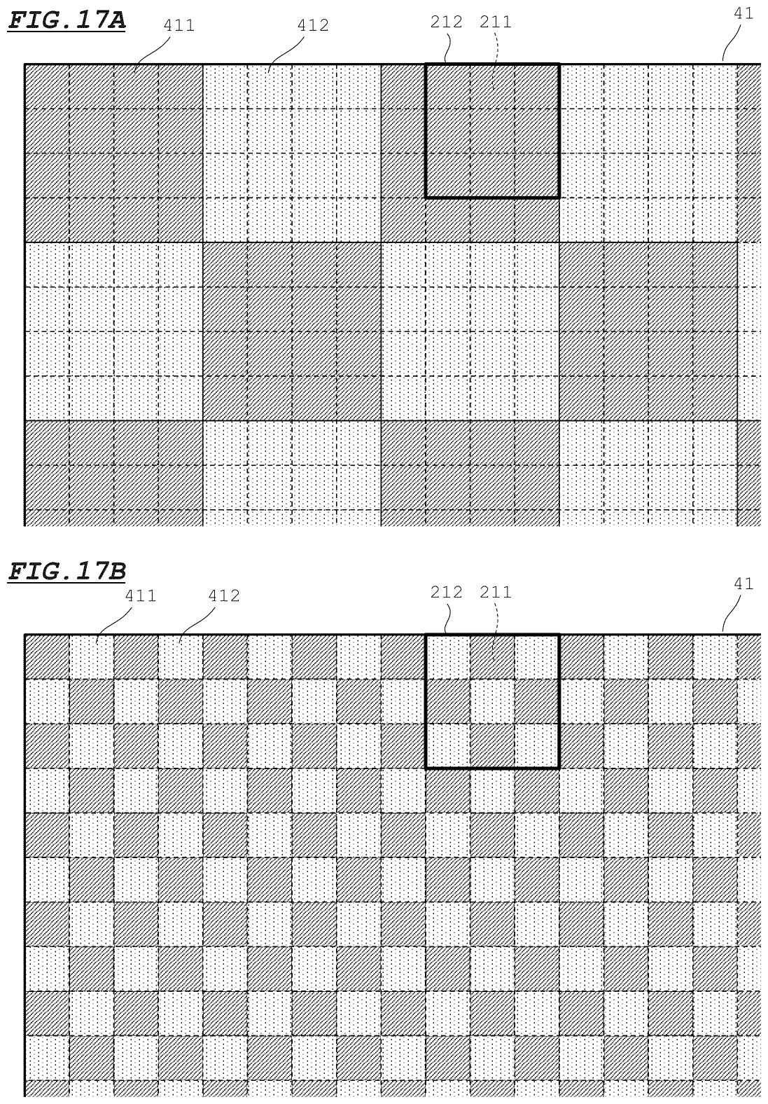

As shown in FIG. 17A, the sizes of the first regions 411 and 421 and the second regions 412 and 422 may be slightly larger than the sizes of the pixel blocks 212 and 222, or as shown in FIG. 17B, the sizes of the first regions 411 and 421 and the second regions 412 and 422 may be set to be the same as those of the pixel regions 211 and 221, and may be smaller than the sizes of the pixel blocks 212 and 222.

However, when the sizes of the first regions 411 and 421 and the second regions 412 and 422 are integer multiples of the sizes of the pixel blocks 212 and 222, as shown in FIG. 6A, the pixel blocks 212 and 222 at the positions corresponding to the first regions 411 and 421 include the entire pattern (dots DT) of the pattern light that should originally be included. Therefore, a stereo correspondence point search for these pixel blocks 212 and 222 can be accurately performed, and as a result, distance calculation for these pixel blocks 212 and 222 can be accurately performed. In addition, since the accuracy of distance calculation for these pixel blocks 212 and 222 is high, distance interpolation for pixel blocks adjacent to the pixel blocks 212 and 222 can also be accurately performed.

Meanwhile, when the sizes of the first regions 411 and the second regions 412 are smaller than the size of the pixel block 212 as shown in FIG. 17B, the interval between the adjacent second regions 412 is narrow, so that, when the first regions 411 are interpolated with the pixel signals for the regions corresponding to the second regions 412, the interpolation can be performed smoothly, and a luminance image having a high quality can be generated. Therefore, in order to generate a luminance image having a higher quality, it is preferable that the sizes of the first regions 411 and 421 and the second regions 412 and 422 are smaller than the sizes of the pixel blocks 212 and 222, and it is more preferable that the sizes of the first regions 411 and 421 and the second regions 412 and 422 are the same as the sizes of the pixel regions 211 and 221 as in FIG. 17B.

### <Modification 5>

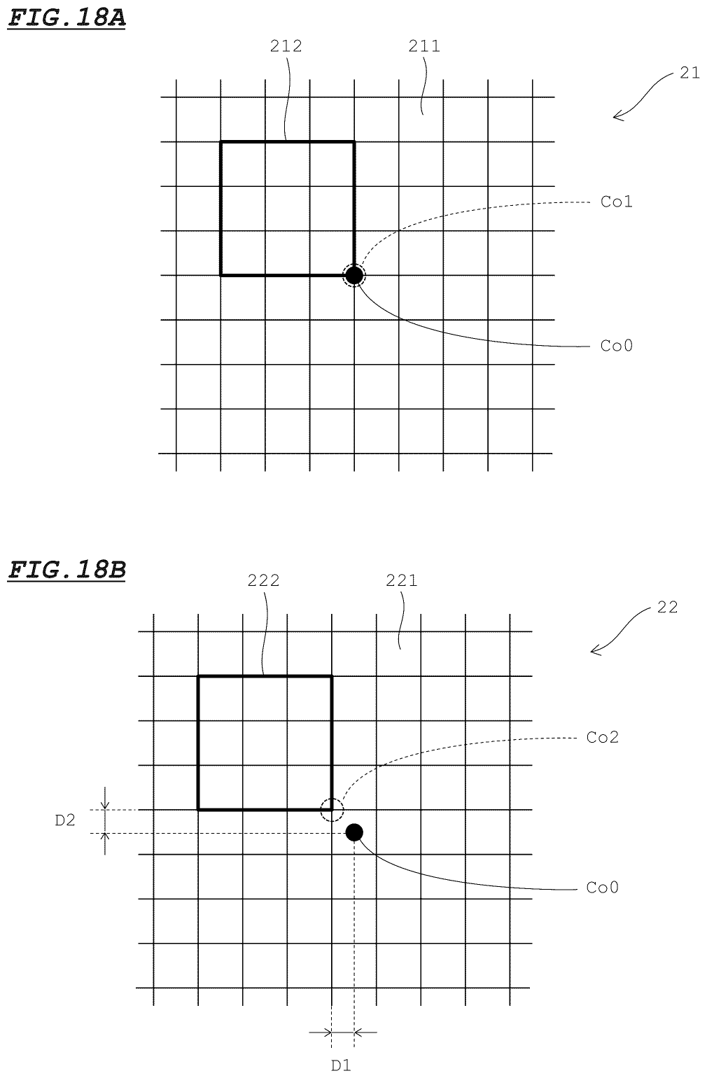

In the above embodiment, as shown in FIG. 3A and FIG. 3B, the arrangement pattern of the pixel regions 211 of the first imaging element 21 with respect to the optical axis center Co0 of the imaging lens 24 and the arrangement pattern of the pixel regions 221 of the second imaging element 22 with respect to the optical axis center Co0 of the imaging lens 24 are the same, but these arrangement patterns with respect to the optical axis center Co0 may be different from each other as shown in FIG. 18A and FIG. 18B. In the example in FIG. 18B, the center Co2 of the imaging surface of the second imaging element 22 is shifted relative to the optical axis center Co0 of the imaging lens 24 in the right-left direction and the up-down direction by distances D1 and D2 which are half a pixel. Therefore, the arrangement pattern of the pixel regions 221 of the second imaging element 22 with respect to the optical axis center Co0 of the imaging lens 24 is shifted relative to the arrangement pattern of the pixel regions 211 of the first imaging element 21 with respect to the optical axis center Co0 of the imaging lens 24 in the right-left direction and the up-down direction by half a pixel.

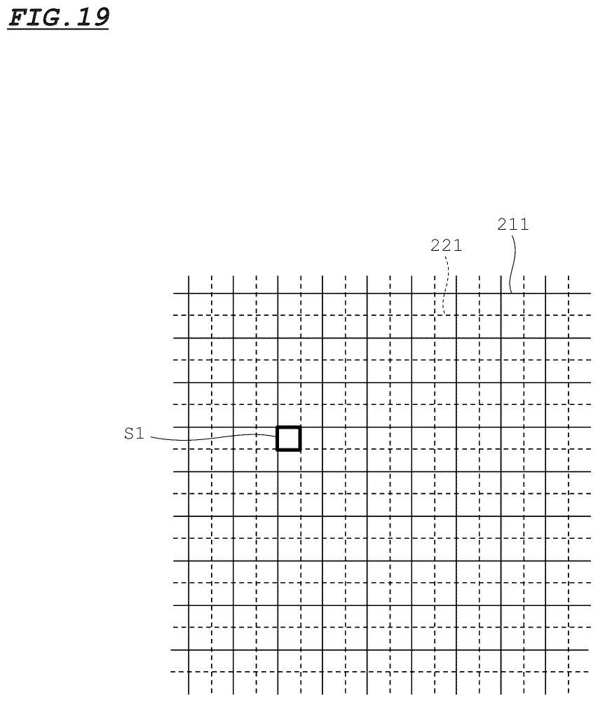

When the arrangement patterns of the pixels of the first imaging element 21 and the second imaging element 22 are adjusted as described above, a luminance image having a resolution higher than that of the pixel regions 211 and 221 can be acquired as shown in FIG. 19 by superimposing the luminance image acquired by the first imaging element 21 and the luminance image acquired by the second imaging element 22 and performing an interpolation process. In FIG. 19, the pixel regions 211 of the first imaging element 21 are shown by solid lines, and the pixel regions 221 of the second imaging element 22 are shown by broken lines. In the example in FIG. 19, the unit of the resolution of the luminance image acquired by the interpolation process is the size of a region S1, and this size is ¼ of the size of the pixel region 211 or 221.

Similarly, a distance image having a resolution higher than that of the pixel regions 211 and 221 can be acquired by superimposing the distance image acquired by the first imaging element 21 and the distance image acquired by the second imaging element 22 and performing an interpolation process.

The shift of the center Co2 of the imaging surface of the second imaging element 22 with respect to the optical axis center Co0 of the imaging lens 24 is not limited to a shift by half a pixel in the right-left direction and the up-down direction. For example, a shift may occur only in the up-down direction, or a shift may occur only in the right-left direction.

The magnitude of the shift is not limited to half a pixel, and may be an integer pixel. For example, when filters 41 and 42 having the same configuration as shown in FIG. 5A and FIG. 5B are formed on the first imaging element 21 and the second imaging element 22, if the shift is set to one pixel, the above-described resolution improvement cannot be achieved, but as in FIG. 10A and FIG. 10B, the arrangement patterns of the first regions and the second regions can be reversed between the first imaging element 21 and the second imaging element 22.

Furthermore, the shift may be based on the difference between the center Co1 of the imaging surface of the first imaging element 21 and the center Co2 of the imaging surface of the second imaging element 22, instead of being based on the difference from the optical axis center Co0 of the imaging lens 24.

### Other Modifications

In the above embodiment, the light received by the imaging lens 24 is split by the light-splitting element 23, and the two split lights are guided to the first imaging element 21 and the second imaging element 22, respectively, but the number of lights into which the light received by the imaging lens 24 is split and the number of imaging elements that receive the split lights are not limited thereto.

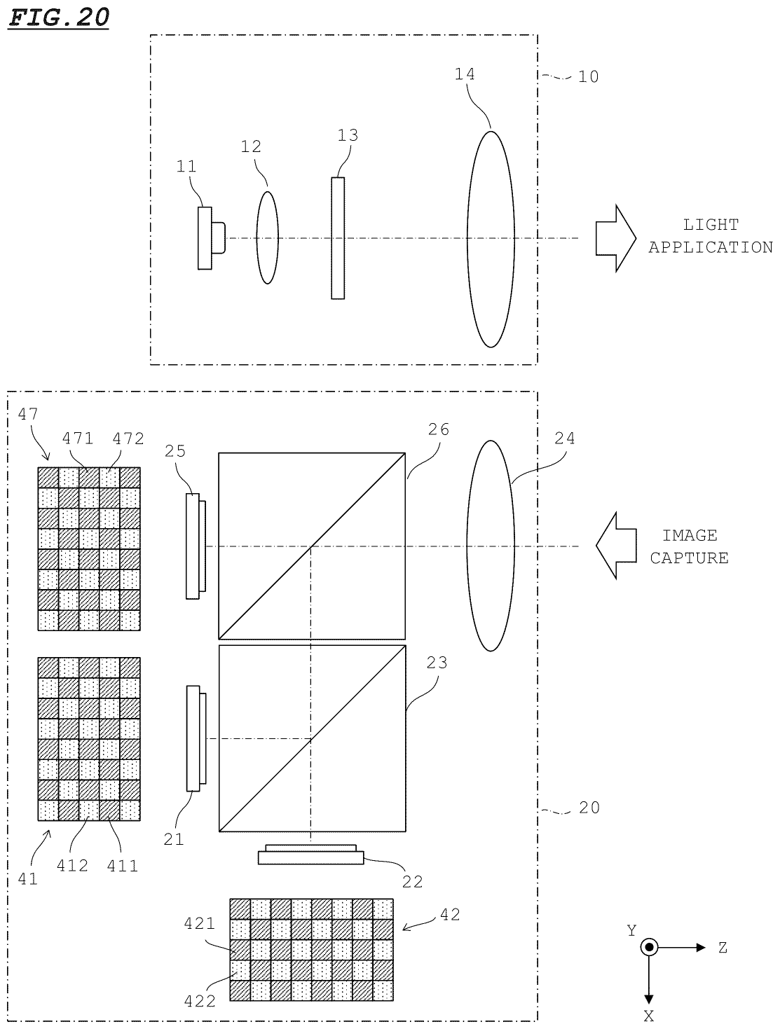

For example, as shown in FIG. 20, the light received by the imaging lens 24 may be split into three lights by the two light-splitting elements 23 and 26, and these three lights may be guided to the first imaging element 21, the second imaging element 22, and the third imaging element 25, respectively. In this case, as in the first filter 41 and the second filter 42, first regions 471 which transmit light in the emission wavelength band of the light source 11 and do not transmit light in other wavelength bands and second regions 472 which do not transmit light in the emission wavelength band of the light source 11 and transmit light in other wavelength bands, are arranged in a third filter 47 formed on the imaging surface of the third imaging element 25. The arrangement pattern of the first regions 471 and the second regions 472 may be the same as in the first filter 41 and the second filter 42.

With this configuration, by applying the same process as that for the first captured image and the second captured image captured by the first imaging element 21 and the second imaging element 22 to the third captured image captured by the third imaging element 25, a luminance image and a distance image based on the third captured image are generated. Therefore, even if a failure or the like occurs in both the first imaging element 21 and the second imaging element 22, the luminance image and the distance image based on the third captured image can be provided to the external device.

By making a third exposure time for the third imaging element 25 different from the first exposure time and the second exposure time for the first captured image and the second captured image, the range (dynamic range) where a luminance image and a distance image can be acquired can be further expanded.

In the process in FIG. 9, after steps S101 to S106 and steps S107 to S112 are executed, selection of a luminance image and selection of a distance image are performed in steps S113 and S114. However, the order of the selection steps is not limited thereto. First, which of the first imaging element 21 and the second imaging element 22 is used to acquire a luminance image and a distance image may be selected, and a luminance image and a distance image may be generated using only the selected imaging element. For example, when a defect occurs in the second imaging element 22, a luminance image and a distance image may be generated by executing only steps S101 to S106 without executing steps S107 to S112, and the generated luminance image and distance image may be transmitted.

The emission wavelength of the light source 11 does not necessarily have to be in the infrared wavelength band, and may be, for example, in the visible wavelength band. In this case, the first regions 411 transmit light in the emission wavelength band of the light source 11 in the visible wavelength band and do not transmit light in other wavelength bands, and the second regions 412 do not transmit light in the emission wavelength band of the light source 11 in the visible wavelength band and transmit light in other wavelength bands. In addition, the emission wavelength band of the second regions 412 does not necessarily have to be in the visible wavelength band, and may be in the infrared wavelength band.

The arrangement pattern of the first regions 411 and the second regions 412 in the first filter 41 and the arrangement pattern of the first regions 421 and the second regions 422 in the second filter 42 are not limited to the arrangement patterns shown in the above embodiment and Modification 1. For example, the sizes of the first regions 411 and the second regions 412 may be different from each other, and the interval between the adjacent first regions 411 and the interval between the adjacent second regions 412 may be different form each other.

In Modifications 2 and 3 above, two types of pattern lights having different wavelength bands are projected from the one projector 10 to a subject, but two types of pattern lights having different wavelength bands may be projected from two projectors, respectively, to a subject.

In the above embodiment, the search range for the stereo correspondence point search is in the row direction, but the search range may be in the column direction, or the search range may be in a combination of the row and column directions.

The first imaging processor 33 and the second imaging processor 34 may correct distortion due to distortion of the imaging lens 24, etc., for the first captured image and the second captured image, or may correct distortion due to distortion of the imaging lens 24, etc., for the standard image stored in advance in the signal processor 31.

In the above embodiment, the correlation value is obtained for each pixel block, but correlation values between the pixel blocks may be further acquired by a process such as parabolic fitting, and a correspondence point search may be performed.

The configuration of the imaging device 1 is not limited to the configuration shown in the above embodiment, and, for example, a photosensor array having a plurality of photosensors arranged in a matrix may be used as each of the first imaging element 21 and the second imaging element 22.

In addition to the above, various modifications can be made as appropriate to the embodiment of the present invention, without departing from the scope of the technological idea defined by the claims.

What is claimed is:

1. An imaging device comprising
an imager, and
a projector configured to project pattern light in a first wavelength band to a field-of-view range of the imager, wherein
the imager includes:
a first imaging element;
a second imaging element;
an imaging lens;
a light-splitting element configured to guide light, from a subject, condensed by the imaging lens, to the first imaging element and the second imaging element;
a first filter formed on a light-receiving surface of the first imaging element and having a plurality of first regions configured to transmit light in the first wavelength band and a plurality of second regions configured not to transmit light in the first wavelength band and to transmit light in a second wavelength band different from the first wavelength band; and
a second filter formed on a light-receiving surface of the second imaging element and having a plurality of the first regions and a plurality of the second regions.

2. The imaging device according to claim 1, wherein an arrangement pattern of the first regions and the second regions in the first filter and an arrangement pattern of the first regions and the second regions in the second filter are the same as each other.

3. The imaging device according to claim 1, wherein an arrangement pattern of the first regions and the second regions in the first filter and an arrangement pattern of the first regions and the second regions in the second filter are different from each other.

4. The imaging device according to claim 1, wherein
the first regions and the second regions are alternately arranged in the first filter, and
the first regions and the second regions are alternately arranged in the second filter.

5. The imaging device according to claim 1, wherein each of the first regions is set with a size including M pixels (M is a natural number) in a horizontal direction and N pixels (N is a natural number) in a vertical direction.

6. The imaging device according to claim 1, wherein an arrangement pattern of pixels of the first imaging element with respect to an optical axis center of the imaging lens and an arrangement pattern of pixels of the second imaging element with respect to the optical axis center of the imaging lens are the same as each other.

7. The imaging device according to claim 1, wherein an arrangement pattern of pixels of the first imaging element with respect to an optical axis center of the imaging lens and an arrangement pattern of pixels of the second imaging element with respect to the optical axis center of the imaging lens are different from each other.

8. The imaging device according to claim 1, wherein
the first wavelength band is a wavelength band included in a non-visible band, and
the second wavelength band is a wavelength band included in a visible band.

9. The imaging device according to claim 1, further comprising a signal processor configured to process pixel signals acquired from the first imaging element and the second imaging element, respectively, to calculate a distance from the subject to each position and generate an image of the subject.

10. The imaging device according to claim 9, wherein
the first imaging element acquires the pixel signals with a first exposure time, and
the second imaging element acquires the pixel signals with a second exposure time different from the first exposure time.

11. The imaging device according to claim 9, wherein the signal processor selects pixel signals for calculating the distance and generating the image from the pixel signals acquired from the first imaging element and the second imaging element, respectively, according to a predetermined selection condition.

12. The imaging device according to claim 11, wherein the selection condition includes presence or absence of a failure in the first imaging element and the second imaging element, and a reflectance of the subject or a light absorption rate of the subject.

13. The imaging device according to claim 1, wherein each of the first regions is set with a size that is an integer multiple (not including 0) of a pixel block that is a smallest unit of distance detection.

14. The imaging device according to claim 1, wherein the projector projects not only pattern light in the first wavelength band but also pattern light in the second wavelength band to the field-of-view range.

15. The imaging device according to claim 10, further comprising a signal processor configured to process pixel signals acquired from the first imaging element and the second imaging element, respectively, to calculate a distance from the subject to each position for each of the pattern lights in the first wavelength band and the second wavelength band.
